(19) United States
(12) Patent Application Publication
(10) Pub. No.: US 2026/0212249 A1
(43) Pub. Date: Jul. 23, 2026

(54) PULSE OPTIMIZATION IN QUANTUM COMPUTING

(71) Applicants: BAR ILAN UNIVERSITY, Ramat Gan (IL); YISSUM RESEARCH DEVELOPMENT COMPANY OF THE HEBREW UNIVERSITY OF JERUSALEM LTD., Jerusalem (IL)

(72) Inventors: Adi MACMEL, Tel-Aviv Yafo (IL); Noga ENTIN, Holon (IL); Mor ROSES, Ramat-Gan (IL); Reuven COHEN, Petach Tikva (IL); Nadav KATZ, Jerusalem (IL)

(21) Appl. No.: 19/454,548

(22) Filed: Jan. 21, 2026

Related U.S. Application Data
(60) Provisional application No. 63/747,960, filed on Jan. 22, 2025.

(51) Int. Cl. G06N 10/60; G06N 10/20; G06N 10/40

(52) U.S. Cl. CPC G06N 10/60; G06N 10/20; G06N 10/40

(57) ABSTRACT

A method and system are presented for pulse optimization in quantum computing (QC) performed by a QC system comprising q qubits (q≥2), each operated by a tunable single-qubit control channel and tunable two-qubit interaction channels. Cost function data for a selected variational quantum algorithm is defined as ƒ_{C}( [symbol] ), where [symbol] is a vector of pulse parameters predefined by: Discretizing a continuous pulse into a pulse sequence of N pulses, each of duration dt, and representing each of single-qubit control and two-qubit interaction pulses by said sequence, where single-qubit control pulse sequence is represented by a time-dependent complex amplitudes dₖ(t) and two-qubit interaction pulse sequence is represented by a time-dependent complex amplitudes u_{{k,l}}(t); and iteratively varying values of \vec{θ} while evaluating the cost function ƒ_{C}( [symbol] ) by measurements of qubits, wherein the pulse parameters at each time bin are independently optimized as free parameters to obtain minimized cost function ƒ_{C}( [symbol] ).

### CROSS-REFERENCES TO RELATED APPLICATIONS

The present application claims benefit from U.S. Provisional Patent Application No. 63/747,960 filed on Jan. 22, 2025, and incorporated hereby by reference in its entirety.

### TECHNOLOGICAL FIELD

The present disclosure is in the field of quantum computing, and relates to a method and system for pulse optimization, in particular pulses used for implementing quantum gates.

### BACKGROUND ART

References considered to be relevant as background to the presently disclosed subject matter are listed below:
1. J. Preskill, Quantum computing in the NISQ era and beyond, Quantum 2, 79 (2018).
2. K. Bharti, A. Cervera-Lierta, T. H. Kyaw, T. Haug, S. Alperin-Lea, A. Anand, M. Degroote, H. Heimonen, J. S. Kottmann, T. Menke, W.-K. Mok, S. Sim, L.-C. Kwek, and A. Aspuru-Guzik, Noisy intermediate-scale quantum algorithms, Reviews of Modern Physics 94, 10.1103/revmodphys. 94.015004 (2022).
3. M. Cerezo, A. Arrasmith, R. Babbush, S. C. Benjamin, S. Endo, K. Fujii, J. R. McClean, K. Mitarai, X. Yuan, L. Cincio, et al., Variational quantum algorithms, Nature Reviews Physics 3, 625 (2021)
4. C. Bravo-Prieto, R. LaRose, M. Cerezo, Y. Subasi, L. Cincio, and P. J. Coles, Variational quantum linear solver, Quantum 7, 1188 (2023).
5. S. Mangini, Variational quantum algorithms for machine learning: theory and applications (2023), arXiv:2306.09984 [quant-ph].
6. M. Cerezo, A. Arrasmith, R. Babbush, S. C. Benjamin, S. Endo, K. Fujii, J. R. McClean, K. Mitarai, X. Yuan, L. Cincio, et al., Variational quantum algorithms, Nature, Reviews Physics 3, 625 (2021).
7. H. R. Grimsley, S. E. Economou, E. Barnes, and N. J. Mayhall, An adaptive variational algorithm for exact molecular simulations on a quantum computer, Nature Communications 10, 10.1038/s41467-019-10988-2 (2019).
8. M. Ostaszewski, L. M. Trenkwalder, W. Masarczyk, E. Scerri, and V. Dunjko, Reinforcement learning for optimization of variational quantum circuit architectures, in Advances in Neural Information Processing Systems Vol. 34, edited by M. Ranzato, A. Beygelzimer, Y. Dauphin, P. Liang, and J. W. Vaughan (Curran Associates, Inc., 2021) pp. 18182-18194.
9. Z. He, X. Zhang, C. Chen, Z. Huang, Y. Zhou, and H. Situ, A GNN-based predictor for quantum architecture search, Quantum Information Processing 22, 128 (2023).
10. L. Ding and L. Spector, Multi-objective evolutionary architecture search for parameterized quantum circuits, Entropy 25, 93 (2023).
11. Z. Liang, J. Cheng, H. Ren, H. Wang, F. Hua, Z. Song, Y. Ding, F. Chong, S. Han, Y. Shi, and X. Qian, Napa: Intermediate-level variational native-pulse ansatz for variational quantum algorithms (2023), arXiv:2208.01215 [quant-ph].
12. C. P. Koch, U. Boscain, T. Calarco, G. Dirr, S. Filipp, S. J. Glaser, R. Kosloff, S. Montangero, T. SchulteHerbruggen, D. Sugny, et al., Quantum optimal control in quantum technologies. strategic report on current status, visions and goals for research in europe, EPJ Quantum Technology 9, 19 (2022)
13. Z. Zong, Z. Sun, Z. Dong, C. Run, L. Xiang, Z. Zhan, Q. Wang, Y. Fei, Y. Wu, W. Jin, et al., Optimization of a controlled-z gate with data-driven gradient-ascent pulse engineering in a superconducting-qubit system, Physical Review Applied 15, 064005 (2021).
14. X. Li, Optimal control of quantum state preparation and entanglement creation in two-qubit quantum system with bounded amplitude, Scientific Reports 13, 14734 (2023).
15. Z. An and D. Zhou, Deep reinforcement learning for quantum gate control, Europhysics Letters 126, 60002 (2019)
16. R. Porotti, V. Peano, and F. Marquardt, Gradientascent pulse engineering with feedback, PRX Quantum 4, 030305 (2023)
17. A. B. Magann, C. Arenz, M. D. Grace, T.-S. Ho, R. L. Kosut, J. R. McClean, H. A. Rabitz, and M. Sarovar, From pulses to circuits and back again: A quantum optimal control perspective on variational quantum algorithms, PRX Quantum 2, 010101 (2021).
18. Z. Liang, J. Cheng, H. Ren, H. Wang, F. Hua, Z. Song, Y. Ding, F. T. Chong, S. Han, X. Qian, et al., Napa: intermediate-level variational native-pulse ansatz for variational quantum algorithms, IEEE Transactions on Computer-Aided Design of Integrated Circuits and Systems 10.1109/TCAD. 2024.3355277 (2024).
19. Qian, S. Han, W. Jiang, and Y. Shi, Variational quantum pulse learning, in 2022 IEEE International Conference on Quantum Computing and Engineering (QCE) (IEEE Computer Society, 2022) pp. 556-565.
20. Z. Liang, Z. Song, J. Cheng, Z. He, J. Liu, H. Wang, R. Qin, Y. Wang, S. Han, X. Qian, and Y. Shi, Hybrid gate-pulse model for variational quantum algorithms (2022), arXiv:2212.00661 [quant-ph].
21. D. Meirom and S. H. Frankel, Pansatz: Pulse-based ansatz for variational quantum algorithms, Frontiers in Quantum Science and Technology 2, 1273581 (2023)
22. D. J. Egger, C. Capecci, B. Pokharel, P. K. Barkoutsos, L. E. Fischer, L. Guidoni, and I. Tavernelli, A study of the pulse-based variational quantum eigensolver on cross-resonance based hardware (2023), arXiv:2303.02410 [quant-ph].
23. X. Pan, X. Cao, W. Wang, Z. Hua, W. Cai, X. Li, H. Wang, J. Hu, Y. Song, D.-L. Deng, et al., Experimental quantum end-to-end learning on a superconducting processor, npj Quantum Information 9, 18 (2023).
24. O. R. Meitei, B. T. Gard, G. S. Barron, D. P. Pappas, S. E. Economou, E. Barnes, and N. J. Mayhall, Gate-free state preparation for fast variational quantum eigensolver simulations, npj Quantum Information 7, 155 (2021).
25. R. De Keijzer, O. Tse, and S. Kokkelmans, Pulse based variational quantum optimal control for hybrid quantum computing, Quantum 7, 908 (2023).
26. D. Yoffe, A. Natan, and A. Makmal, A qubit-efficient variational selected configuration-interaction method (2023), arXiv:2302.06691 [quant-ph].
27. L. Innocenti, G. De Chiara, M. Paternostro, and R. Puebla, Ultrafast critical ground state preparation via bang-bang protocols, New Journal of Physics 22, 093050 (2020).
28. A. Asthana, C. Liu, O. R. Meitei, S. E. Economou, E. Barnes, and N. J. Mayhall, Leakage reduces device coherence demands for pulse-level molecular simulations, Physical Review Applied 19, 064071 (2023)
29. A. Blais, A. L. Grimsmo, S. M. Girvin, and A. Wallraff, Circuit quantum electrodynamics, Reviews of Modern Physics 93, 025005 (2021)
30. N. M. Tubman, C. D. Freeman, D. S. Levine, D. Hait, M. Head-Gordon, and K. B. Whaley, Modern approaches to exact diagonalization and selected configuration interaction with the adaptive sampling CI method, Journal of chemical theory and computation 16, 2139 (2020)
31. S. Bravyi, S. Sheldon, A. Kandala, D. C. Mckay, and J. M. Gambetta, Mitigating measurement errors in multiqubit experiments, Physical Review A 103, 042605 (2021).
32. D. Wierichs, J. Izaac, C. Wang, and C. Y.-Y. Lin, General parameter-shift rules for quantum gradients, Quantum 6, 677 (2022).
33. O. Kyriienko and V. E. Elfving, Generalized quantum circuit differentiation rules, Physical Review A 104, 052417 (2021).
34. K. Kottmann and N. Killoran, Evaluating analytic gradients of pulse programs on quantum computers (2023), arXiv:2309.16756 [quant-ph].

Acknowledgement of the above references herein is not to be inferred as meaning that these are in any way relevant to the patentability of the presently disclosed subject matter.

### BACKGROUND

The limitations of the current generation of noisy inter-mediate scale quantum (NISQ) devices, which are prone to gate and read-out errors, pose a significant obstacle in realizing the full potential of quantum computers [1, 2]. Gate errors accumulate rapidly with the circuit's depth, which imposes constraints on the number of gates that can be practically used and significantly restricts the range of algorithms that can be executed.

Variational quantum algorithms (VQAs) [3-5], which tune parameterized quantum gates towards the optimization of a problem-related cost function, have gained popularity as a mean to leverage NISQ devices due to their characteristic shallow circuits. Yet, despite utilizing relatively short-depth quantum circuits, VQAs still suffer from hardware noise, leading to limited performance [6].

Consequently, several studies have devised new quantum circuit architecture designs for shortening the VQAs circuit Ansatz [7-10], leading for example, to circuits duration of the order of hundreds nano-seconds (ns) for finding the groundstate of the H₂ molecule (using 2 qubits), which is, however, still too long for the current level of hardware noise [11]. An alternative approach towards the reduction of quantum processing time has been recently attempted via direct manipulation of the hardware degrees of freedom.

Different quantum hardware technologies implement quantum operations through different types of tunable hardware degrees-of-freedom. In superconducting qubits, for example, each quantum gate is implemented via a fixed set of microwave pulses. Quantum optimal control (QOC) techniques, such as gradient ascent pulse engineering (GRAPE) [12], can be used to improve the fidelity of the gates and speedup the circuits' execution times. In addition, pulse optimization can be utilized for state-preparation [13] using a genetic optimization protocol, and very recently for two-qubit systems with bounded amplitude. Machine learning techniques have further contributed to the improvement of pulse engineering methods [14, 15].

Electromagnetic pulses serve numerous functions in quantum computing, e.g., to drive operations for controlling and manipulating qubits. Pulse properties, such as frequency, amplitude, and phase, are typically configured to effect specific qubit behavior in the quantum computer, e.g., for entanglement and other gate operations.

In VQAs, pulse optimization aims at the minimization of a predefined cost-function, rather than the precise fidelity of a target gate or state. The earlier techniques [15] have initially explored conceptual connections between QOC and VQAs on a theoretical level [16]. Later on, various concrete strategies emerged, which can be categorized into three groups: gate-based approach, shape-based approach, and square pulse methods.

The gate-based approach places emphasis on leveraging conventional quantum gates, e.g., by transpiling gated-circuit Ansatz, converting them into their pulse-level equivalents, specifically to pulses of the “derivative removal by adiabatic gate” (DRAG) shape, as implemented in IBMQ hardware. Then, these pulses are optimized by adjusting their amplitudes and frequency envelopes. The Shape-based approach builds on familiar pulse shapes, such as Gaussian and DRAG pulses, and tweaks them for single or two-qubit operations. The square pulse method focuses on basic square pulses, adjusting just the amplitudes, for superconducting qubits [24], and via classical simulations on Rydberg atoms hardware [25].

### General Description

Variational pulse optimization aims at the minimization of a predefined VQA cost-function, rather than the precise fidelity of a target gate or state. As noted above, earlier techniques have initially explored conceptual connections between QOC and VQAs on a theoretical level [16], and later on, various concrete strategies emerged, based on the gate-based approach, shape-based approach, and the square pulse method. The latter takes a more straightforward approach with discrete time square pulses, adjusting merely the amplitudes, for superconducting qubits, and via classical simulations on Rydberg atoms hardware.

It should be noted that implanting this method for superconducting gates manipulated merely single qubit's degrees of freedom without controlling the two-qubit channels. Both of the square pulse techniques described in the literature have not utilized full control over two-qubit channels. Instead, they manipulated solely single qubit's degrees of freedom.

The present disclosure provides a novel pulse optimization technique for use in a quantum computing system. The technique of the present disclosure provides a fully flexible scheme that combines the principles of the square-pulse method [24] with direct, bi-directional control over two-qubit channels, and provides for enhancing flexibility, execution speed, and noise resilience. Inspired by machine learning's ability to learn “without being explicitly programmed”, the technique of the present disclosure autonomously discovers the most effective pulses within the device's physical constraints, by tuning the pulse amplitudes across both single and two-qubit channels, at each discrete time step. The pulse optimization technique of the present disclosure is general and can potentially accelerate performance across various quantum computing components and hardware. In the description below, the technique of the present disclosure is exemplified in relation to superconducting qubit systems, but it should be noted that the principles of the present disclosure are not limited to this specific application, and the technique of the present disclosure can be used in any of the following system configurations: superconducting qubit systems, trapped ion systems, neutral atom array systems, quantum dot systems, nitrogen-vacancy center systems, and photonic quantum computing systems.

The technique of the present disclosure provides a freestyle pulse optimization scheme utilizing discretization of a continuous pulse into small time intervals, each with a tunable complex amplitude, that is optimized individually, while accounting directly for dedicated two-qubit pulse channels, thereby facilitating natural and direct entanglement generation, being more compatible with real devices. The freestyle pulse optimization scheme provides full flexibility in pulse design. It should be noted that this freestyle pulse optimization scheme differs from fixed-shape pulse methods in its ability to generate pulses of diverse, irregular, shapes. Additionally, unlike the above-mentioned prior discrete-time pulse methods, the freestyle pulse optimization technique of the present disclosure accommodates two-qubit channels, thus enhancing its efficiency and compatibility with real quantum devices.

According to one broad aspect of the present disclosure, it provides a method for pulse optimization in quantum computing, the method comprising:
providing quantum computing system related data comprising a number q of qubits (q≥2), and time-dependent complex pulse amplitudes dₖ(t) and u_{{k,l}}(t) of, respectively, tunable single-qubit control channels and tunable two-qubit interaction channels of the quantum computing system:
determining data indicative of a cost function ƒ_{C}( [symbol] ) for a selected variational quantum algorithm to be performed by said quantum computing system, where [symbol] is a predefined vector of pulse parameters; wherein said vector of pulse parameters is predefined by carrying out the following:
   discretizing a continuous pulse into a pulse sequence of N pulses, each of duration dt, and representing each of the single-qubit control pulses and each of the two-qubit interaction pulses by the pulse sequence of the N pulses, where the pulse sequence of the single-qubit control pulse is represented by real and imaginary components of the time-dependent complex amplitudes dₖ(t) and the pulse sequence of the control two-qubit interaction pulse is represented by the time-dependent complex amplitudes u_{{k,l}}(t), such that said vector of pulse parameters, [symbol] is a multi-parameter vector across multiple pulse sequences of the single-qubit control pulses and two-qubit interaction pulses;
   starting from initial values for said pulse parameters, optimizing values of the pulse parameters, by iteratively varying said values of pulse parameters of said vector, [symbol] , while evaluating the cost function ƒ_{C}(\vec{θ}) by measurements of the q qubits in said quantum computing system until convergence criteria are met, wherein the pulse parameters at each time bin are independently optimized as free parameters to obtain a minimized cost function ƒ_{C}(\vec{θ}*); and determining an optimized representation [symbol] * of the vector of pulse parameters corresponding to the minimized cost function ƒ_{C}(\vec{θ}*).

The quantum computing system may be configured as one of the following: a superconducting qubit system, trapped ion systems, neutral atom array systems, nitrogen-vacancy center systems, or quantum dot system.

The selected variational quantum algorithm may be selected from the following: Variational Quantum Eigensolver (VQE), Variational Quantum Selected Configuration-Interaction (VQ-SCI), Quantum Approximate Optimization Algorithm (QAOA), and variational quantum machine learning algorithms.

The optimizing of the values of the pulse parameters may include iterative pulse optimization performed using a gradient-free optimizer; or iterative pulse optimization performed using a gradient-based optimizer.

The initial values for the pulse parameters may be set to zero, corresponding to an initial computational basis state of the quantum computing system.

In some embodiments, the convergence criteria comprise at least one of the following: the cost function ƒ_{C}(\vec{θ}) changing by less than a predetermined threshold between consecutive iterations; achieving a target accuracy for the cost function; and reaching a maximum number of iterations. For example, the convergence criteria comprise achieving a target accuracy for the cost function, the target accuracy being chemical accuracy, defined as an energy deviation of ±0.0016 Ha (Hartree) from a Full Configuration Interaction (FCI) energy.

In some embodiments, the cost function ƒ_{C}(\vec{θ}) represents a molecular groundstate energy of a chemical system. The technique may also include determination of a dissociation curve of a molecule by repeating the iterative pulse optimization for multiple interatomic distances.

In some embodiments, the pulse sequence comprises discrete-time pulses with independently tunable amplitude within each time bin dt.

In some embodiments, optimizing the values of the pulse parameters comprises updating the pulse parameters by a classical computer based on the measurements of the q qubits in the quantum computing system.

The duration dt of each pulse in the pulse sequence may be selected based on a characteristic control timescale of the quantum computing system.

As noted above, the quantum computing system may be a superconducting qubit system. The pulse duration dt of each pulse in the pulse sequence may be selected between 0.1 ns and 100 ns based on a characteristic control timescale of the quantum computing system.

In some other embodiments, the quantum computing system may be a trapped ion system, or a neutral atom array system. The pulse duration dt of each pulse in the pulse sequence may be selected between 0.1 s and 100 s based on a characteristic control timescale of the quantum computing system.

The method may include optimization of the number N of pulses and/or the pulse duration dt to provide an optimized total pulse duration N×dt of the pulse sequence to be less than a coherence time of the quantum computing system. The total pulse duration N×dt may be selected to approach a quantum speed limit for state preparation in the quantum computing system.

In some embodiments, the quantum computing system may be configured with all-to-all topology for connecting the q qubits. The total number q² of channels may be defined by number q of the control single-qubit channels and number q(q-1) of the two-qubit interaction channels, providing a total number of 2Nq² of the tunable pulse parameters.

In some other embodiments, the quantum computing system is configured with a linear topology for connecting the q qubits. The total number (3q-2) of channels is defined by number q of the control single-qubit channels and number (q-1) of the two-qubit interaction channels, each of the two-qubit interaction channel having 2 directions of control, providing a total number 2N(3q−2) of the tunable pulse parameters.

The two-qubit interaction channels may be bidirectional, comprising a first interaction channel for qubit k interacting with qubit l and a second interaction channel for the qubit l interacting with the qubit k. Alternatively, the two-qubit interaction channels may be unidirectional.

In some embodiments, the measurements of the q qubits comprise measuring expectation values of observable operators. The observable operators may include at least Pauli \hat{Z} and \hat{X} operators.

Evaluation of the cost function may include: applying the pulse sequence defined by current values of 0\vec{ } to the quantum computing system; performing multiple measurement shots on the q qubits; calculating expectation values from the measurement results; and computing the cost function ƒ_{C}( [symbol] ) from the expectation values.

The method may also include modifying the pulse sequence to meet hardware-specific constraints of the quantum computing system on at least one of the pulse duration dt, timing, and pulse shape.

The method may also include analysis of the iterative pulse optimization performed in a rotating frame or interaction picture corresponding to the quantum computing system. The iterative pulse optimization provides an effective pulse sequence that implements a rotation operation around one or more axes of a Bloch sphere representation.

For the quantum computing system operating in a rotating wave approximation, a real component Re[dk(t)] of the single-qubit control pulse amplitude generates rotation around a first axis of a Bloch sphere representation; and an imaginary component Im[dk(t)] of the single-qubit control pulse amplitude generates rotation around a second orthogonal axis of the Bloch sphere representation.

The method may also include analyzing the measured data to identify and monitor leakage relating errors arising from coupling to states outside a computational subspace of the qubits.

In some embodiments, the method includes cost function minimization for a given variational quantum algorithm with the pulse duration dt at least 10 times shorter than a pulse duration of a gate-based circuit implementing said given variational quantum algorithm.

The minimized cost function f_{C}( [symbol] ) may be obtained subject only to physical amplitude constraints |dₖ(t)²≤1 and |u_{{k,l}}(t)|²≤1, the physical amplitude constraints comprising platform-specific maximum control amplitudes determined by hardware limitations of the quantum computing system.

According to another broad aspect of the present disclosure, it provides a system comprising:
a quantum computing system comprising: a quantum chip comprising q qubits (q≥2), a pulse generator, and a readout circuitry, the quantum computing system defining tunable single-qubit control channels having a time-dependent complex pulse amplitude dₖ(t) and tunable two-qubit interaction channels having a time-dependent complex pulse amplitude u_{{k,l}}(t) for generating entanglement between qubit pairs; and
a control circuitry configured and operable to generate control pulses for the quantum computing system to provide said tunable single-qubit control channels said tunable two-qubit interaction channels, the control circuitry comprising a pulse optimizer configured and operable to utilize said data indicative of the time-dependent complex pulse amplitudes dₖ(t) and u_{{k,l}}(t) and transfer a continuous pulse into an optimized pulse sequence representation corresponding to a minimized cost function for a selected variational quantum algorithm to be performed by said quantum computing system, by carrying out the following:
representing the cost function as ƒ_{C}( [symbol] ), where \vec{θ} is a predefined vector of pulse parameters;
discretizing the continuous pulse into a pulse sequence of N pulses, each of a pulse duration dt, and representing each of the single-qubit control pulses and each of the two-qubit interaction pulses by the pulse sequence of the N pulses, where the pulse sequence of the single-qubit control pulse is represented by real and imaginary components of the time-dependent complex amplitudes dₖ(t) and the pulse sequence of the control two-qubit interaction pulse is represented by the time-dependent complex amplitudes u_{{k,l}}(t), such that said vector of pulse parameters, \vec{θ}, is a multi-parameter vector across multiple pulse sequences of the single-qubit control pulses and two-qubit interaction pulses;
optimizing values of the pulse parameters, by iteratively varying said values of pulse parameters of said vector, \vec{θ}, starting from selected initial values, while evaluating the cost function ƒ_{C}(\vec{θ}) by using measured data provided the classical controller and being indicative of measurements of the q qubits in said quantum computing system, until convergence criteria for the cost function are met, wherein the pulse parameters at each time bin are independently optimized as free parameters to obtain a minimized cost function ƒ_{C}( [symbol] ); and
determining an optimized representation [symbol] of the vector of pulse parameters corresponding to the minimized cost function ƒ_{C} ( [symbol] ).

According to yet further broad aspect of the present disclosure, it provides a control circuitry configured and operable to generate control pulses for a qubit chip of a quantum computing system, the control circuitry comprising a pulse optimizer configured and operable to carry out the following:
utilize data indicative of a number q of 2 or more qubits in said qubit chip, and time-dependent complex pulse amplitudes dₖ(t) and u_{{k,l}}(t) of, respectively, tunable single-qubit control channels and tunable two-qubit interaction channels of the quantum computing system and determine a cost function for a selected variational quantum algorithm to be performed by said quantum computing system as ƒ_{C}( [symbol] ), where \vec{θ}is a predefined vector of pulse parameters
optimize said vector of pulse parameters to minimize the cost function by carrying out the following:
   discretizing the continuous pulse into a pulse sequence of N pulses, each of a pulse duration dt, and representing each of the single-qubit control pulses and each of the two-qubit interaction pulses by the pulse sequence of the N pulses, where the pulse sequence of the single-qubit control pulse is represented by real and imaginary components of the time-dependent complex amplitudes dₖ(t) and the pulse sequence of the control two-qubit interaction pulse is represented by the time-dependent complex amplitudes u_{{k,l}}(t), such that said vector of pulse parameters, \vec{θ}, is a multi-parameter vector across multiple pulse sequences of the single-qubit control pulses and two-qubit interaction pulses;
   optimizing values of the pulse parameters, by iteratively varying said values of pulse parameters of said vector, \vec{θ}, starting from selected initial values, while evaluating the cost function ƒ_{C}(\vec{θ}) by using measured data provided the classical controller and being indicative of measurements of the q qubits in said quantum computing system, until convergence criteria for the cost function are met, wherein the pulse parameters at each time bin are independently optimized as free parameters to obtain a minimized cost function ƒ_{C}( [symbol] ); and
   determining an optimized representation [symbol] of the vector of pulse parameters corresponding to the minimized cost function ƒ_{C}( [symbol] ).

As noted above, in some embodiments, the cost function ƒ_{C}( [symbol] ) represents a molecular groundstate energy of a chemical system.

The technique of the disclosure was tested on groundstate calculations of the H₂ and LiH molecules and demonstrated a significant reduction in pulse duration, up to three orders of magnitude, and substantially improved accuracy compared to previous gate-based and pulse-based results on real hardware. The reduction in pulse duration was achieved in two steps: first, the qubit-efficient variational quantum selected-configuration-interaction (VQSCI) scheme [26] was employed, which finds molecular groundstates using relatively few qubits and shallow circuits; and second, the VQ-SCI gated Ansatz was replaced with the “freestyle” pulse of the present disclosure, thereby reducing the pulse duration further. Notably, the sufficiency of the exceptionally short pulses aligns with the “bang-bang” control theory principles, advocating for abrupt and robust control applications for quick and efficient outcomes [27-28].

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIG. 1 is a block diagram of a quantum computing system configured and operable according to the technique of the present disclosure;

FIG. 2 is a flow diagram exemplifying a pulse optimization technique of the present disclosure suitable to be implemented by the control circuitry of the system of FIG. 1;

FIG. 3 illustrates the freestyle pulse optimization scheme of the present disclosure;

FIG. 4 shows results of noisy simulations for H₂ at the equilibrium distance with a 0.22 ns pulse;

FIGS. 5A and 5B show results of noisy simulations for H₂, wherein FIG. 5A shows groundstate total energy per interatomic distance, and FIG. 5B shows zoom-in view of energy error relative to exact FCI; error bars present the standard deviation of the last 10 iterations; the dashed green line and the green area mark the FCI energy and the c.a. region;

FIG. 6 shows results of noisy simulations for H₂ wherein the minimal pulse duration for achieving c.a. is plotted per interatomic distance, for the gated model (red) and the freestyle pulse (blue), along the resulting pulses of both methods;

FIG. 7 shows real-hardware (ibmq_jakarta) results for H₂ at equilibrium distance, wherein percentage error deviation from exact FCI energy is shown per iteration: averaged over 3Ry gate experiments (red), averaged over 4 freestyle 0.22 ns pulse experiments, and a single freestyle pulse experiment (cyan); the dark green curve depicts the minimal accumulated error at each iteration; the light green area marks the c.a. region;

FIGS. 8A and 8B show IQ measurement points, in the z (FIG. 8A) and x (FIG. 8B) basis, classified to the |0 [symbol] , |1 [symbol] amd |2 [symbol] states; the measurements were done in the final H₂ VQ-SCI iteration; the I and Q data points are normalized by a factor of 108; each dot corresponds to a single measured shot on the quantum computer; the solid line represents the classification to |0 [symbol] and |1 [symbol] ;

FIG. 9 shows results of simulating the evolution of a 4-level system, starting from the |0> state, under a constant pulse of maximal amplitude, as a function of time;

FIG. 10 shows real-hardware (ibmq_brisbane) freestyle pulse results for LiH at equilibrium distance using 10³ shots; percentage error deviation from exact FCI energy shown in absolute value, per iteration; the dark green curve depicts the minimal accumulated error at each iteration; the light green area marks the c.a. region;

FIG. 11A is an illustration of the 3-qubit topology featuring three drive channels, one assigned to each qubit i, and two control channels, denoted as u_{k,l}, where k is the controlling qubit and 1 is the target qubit; FIG. 11B shows the real-hardware pulse schedule that most closely approximated the FCI groundstate energy for LiH (found at the 23rd iteration, see FIG. 10); the y-axis displays the optimized pulse amplitudes, while the x-axis outlines the timeline of the pulse; solid and dotted lines indicate real and imaginary components of the pulse amplitudes, respectively; dᵢ denotes the three single-qubit drive channels, and u_{k,l} signifies the two two-qubit control channels;

FIG. 12 shows the error deviation of \hat{X}-\hat{Z} measurement from the expected values of the FCI groundstate on the equilibrium of H₂; the figure illustrates an absolute error analysis for each iteration of the average of the 4 freestyle executions on real-hardware, shown in blue in FIG. 7; the measurement errors for the \hat{X} and \hat{Z}operators are depicted by red and blue lines, respectively; the error bars represent the standard error of the mean (SEM), based on the outcomes of measurement shots.

### DETAILED DESCRIPTION OF EMBODIMENTS

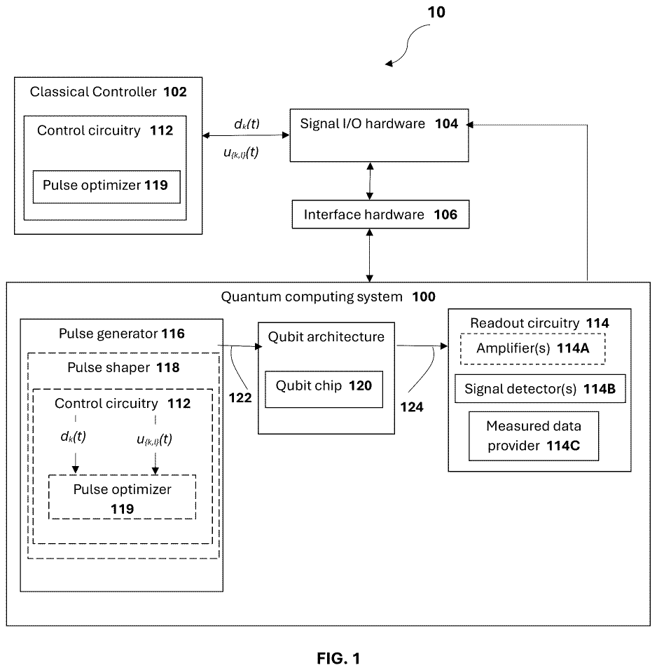

Reference is made to FIG. 1 illustrating, by way of a block diagram, a hybrid system 10 including: a quantum computing system 100, and a classical controller 102. The quantum computing system 100 includes: a pulse driver/generator 116, a quantum architecture part including a quantum chip 120; and a readout circuitry 114. The system 100 is associated with the classical controller 102 (classical control computer) and is connectable to such controller 102 via a signal input/output (I/O) hardware 104 having an appropriate interface hardware 106.

The present disclosure provides the technique of optimization of operational pulses which operate the qubit chip 120 of the quantum computing system. To this end, the present disclosure provides a control circuitry 112 which is typically a part of the classical controller 102. In some cases, the control circuitry 112 might be a part of the pulse generator 116 (i.e., its pulse shaper utility 118), as shown in the figure in dashed lines.

The construction and operation of the quantum computing system 100 does not form part of the present disclosure, and may be of any known suitable type, and therefore need not be described in detail, except to note the following:

The pulse generator 116 is configured and operable to generate electromagnetic pulses (pulse sequences) of a type suitable for the type of the qubit architecture part to control/manipulate the qubits (e.g., microware pulses to manipulate superconducting qubits) in the qubit chip 120. The qubit chip 120 includes one or more quantum processing circuits which exhibit quantum properties (like superposition and entanglement) to encode quantum information, allowing quantum computation. The qubit architecture part (qubit chip 120) may include any number of qubits configured in any manner.

In the description below, the technique of the present disclosure is exemplified in relation to superconducting qubits. However, the qubit chip 120 may include other qubit types including charge qubits, flux qubits, phase qubits, and others.

The readout circuitry 114 includes signal detector(s) 114B and measurement utility 114C operable to provide measured data based on the signals being detected (which are indicative of the measurement results about the quantum states being obtained), and may include suitable amplifier(s) 114A. Considering for example superconducting qubits, the readout circuitry measures the quantum states of the qubits, typically using microwave signals and sensitive amplifiers. The measurement results are used by the measured data provider utility 114C of the readout circuitry 114 which generates corresponding measured data and communicates the measured data to the classical controller 102 for further processing by the classical controller 102 being a computer system.

As non-limiting examples, the readout circuitry 114 may include various resonant cavities, logic circuits, as well as any number of linear and non-linear circuit elements, such as Josephson junctions, inductors, capacitors, resistive elements, superconductive elements, transmission lines, waveguides, gates, and the like. The readout circuitry may be configured and operable to apply readout error mitigation to the measurements of the q qubits. This mitigation is typically based on repetitions (to amplify noise) and classical processing to extrapolate to zero noise.

For the purposes of the present disclosure, the computer system of the classical controller 102 includes the control circuitry 112 configured and operable according to the present disclosure. The control circuitry is a processing and memory circuitry which utilizes quantum system related data (including at least number q of qubits, complex amplitudes of control and interaction channels dₖ(t), u_{{k,l}}(t)) and is responsive to the measured data provided by the readout circuitry 114 to optimize the pulse shape as will be described below.

The classical controller 102 may initiate and control the timing, intensity and repetition of (voltage) pulses being generated by the pulse driver/generator 116. The classical controller 102 is thus configured and operable to process the measured data and generate control signals to the pulse generator 116, as well as to execute quantum simulations. The controller 102 can manage the overall computation and processing of the final results.

The classical controller 102 communicates with the quantum computing system 100 via signal I/O hardware 104, and may be configured to control qubits in the qubit chip 120 via the pulse generator 116 by providing various control signals thereto. The operational signals provided by the pulse generator 116 to the qubit chip 120 may include microwave irradiation signals, current signals, voltage signals, magnetic signals, and so on. To this end, the pulse generator 116 may include various other circuitries, including any number of linear and non-linear circuit elements, such as Josephson junctions, inductors, capacitors, resistive elements, superconductive elements, transmission lines, waveguides, gates, and the like. In some implementations, the signal I/O hardware 104 may include a field programmable gate array (FPGA) configured to generate and provide multi-bit patterns to be used by a pulse driver/generator 116 to control one or more qubits. Control couplings 122 providing a communication between the qubit chip 120 and the pulse generator may be configured to transmit, modulate, amplify, or filter, the pulse sequence generated using the control circuitry 112. Such control couplings 122 may include various circuitry, including capacitive or inductive elements, passive superconducting microstrip lines, active Josephson transmission lines, including any number of Josephson junctions, and so forth. In some aspects, the controller 102 may direct the signal I/O hardware 104 to provide signals for modulating or tuning the control couplings 122 and/or readout couplings 124.

In general, the classical controller 102 may operate the signal I/O hardware 104 to provide various signals to the quantum computing system 100, as well as detect signals therefrom via the interface hardware 106. In some implementations, the controller 102 may also control various other equipment of the system 100, such as various pumps, valves, and so forth. In some aspects, the controller 102 may include a programmable processor or combination of processors, such as central processing units (CPUs), graphics processing units (GPUs), and the like. As such, the controller 102 may be configured to execute instructions stored in a non-transitory computer-readable media. In this regard, the controller 102 may be any computer, workstation, laptop or other general purpose or computing device. Additionally, or alternatively, the controller 102 may also include one or more dedicated processing units or modules that may be configured (e.g. hardwired, or pre-programmed).

The configuration and operation of all such elements are generally known and do not form part of the present disclosure, and therefore need not be specifically described.

According to the technique of the present disclosure, the control circuitry 112 includes a pulse optimizer 119 configured and operable to independently optimize pulse parameters as free parameters to optimize the system performance, i.e., to minimize a cost function of the system operation, i.e., a cost function for a selected variational quantum algorithm to be performed by said quantum computing system. This will be described more specifically further below.

The selected variational quantum algorithm can be selected from the following: Variational Quantum Eigensolver (VQE), Variational Quantum Selected Configuration-Interaction (VQ-SCI), Quantum Approximate Optimization Algorithm (QAOA), and variational quantum machine learning algorithms.

The entire system operates in a carefully orchestrated cycle: the classical controller 102 sends instructions including data indicative of optimized pulse shapes to the pulse generator 116 which generates precise pulses to manipulate the qubits in the qubit chip 120 resulting in quantum operations, and the readout circuitry 114 measures the results, completing the feedback loop.

As noted above, the control circuitry 112 which is part of controller 102 (or may be part of the pulse generator 116) includes pulse optimizer 119 (being a classical optimizer) which is configured and operable according to the present disclosure to apply a freestyle optimization to independently optimize each of the pulse parameters as free parameters to thereby optimize the system performance, i.e., to minimize a cost function of the system operation. Moreover, the freestyle optimization technique of the present disclosure enables to minimize the cost function, subject only to physical amplitude constraints |dₖ(t)|²≤1 and |u_{{k,l}}(t)|²≤1, where dₖ(t) and u_{{k,l}}(t) are time-dependent complex pulse amplitudes of pulses being generated by the pulse generator 116 to implement, respectively, a tunable single-qubit control channel and tunable two-qubit interaction channels in the qubit chip. This will be described more specifically further below.

The technique of the present disclosure for optimizing the pulse shape (pulse parameters) is described here as being used in a superconducting quantum system. However, it should be understood that the principles of the present disclosure are not limited to this specific application, and can also be advantageously used in trapped ion systems, neutral atom array systems, quantum dot systems, nitrogen-vacancy center systems. The qubits may include: transmon qubits, flux qubits, charge qubits, trapped ions, neutral atoms in optical tweezers, Rydberg atoms, semiconductor spin qubits, singlet-triplet qubits, and nitrogen-vacancy centers.

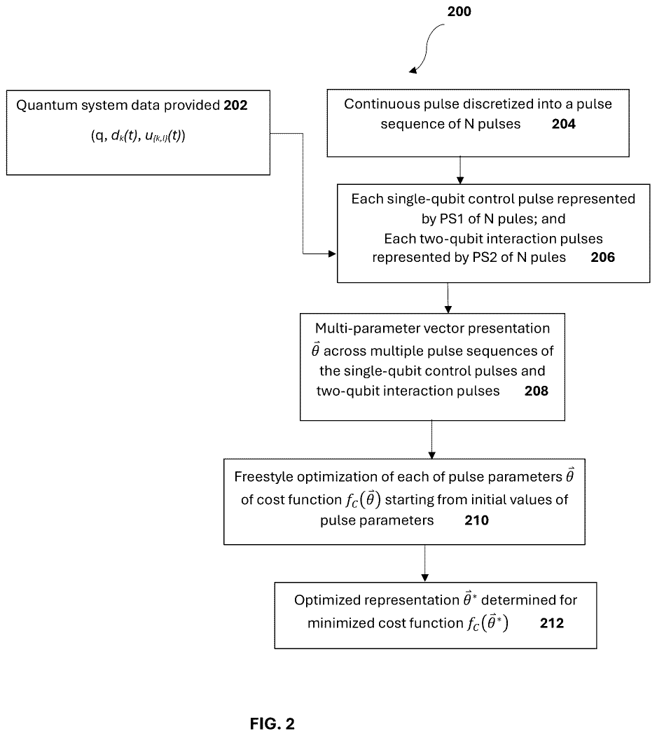

Referring to FIG. 2, there is illustrated a flow diagram 200 of an exemplary method of the present disclosure for implementing a novel pulse shaping technique to optimize the pulse being generated by the pulse generator 116. To this end, quantum system related data is provided (step 202). This data includes a number of qubits in the qubit chip 120 and amplitudes of continuous pulses being generated by the pulse generator 116 in association with the tunable channels.

The qubit chip 120 includes a number q of qubits (q≥2), where each qubit is operated by a tunable single-qubit control channel and by tunable two-qubit interaction channels. As generally known, the tunable single-qubit channel is defined by one specific qubit and independent manipulation of the quantum state of that qubit. Each qubit typically has its own dedicated signal line (transmission line that couples to one qubit's drive port), which might be sometimes shared with nearest neighbors, and has its own flux line (a dedicated low-frequency line that couples to that qubit's SQUID loop). The tunable single-qubit control channel provides control pulses having a time-dependent complex pulse amplitude dₖ(t). As also generally known, the tunable two-qubit interaction channels is defined by a specific pair of qubits and creation of entanglement or conditional operations between them. The tunable two-qubit interaction channels provide two-qubit interaction pulses having a time-dependent complex pulse amplitude u_{{k,l}}(t) for generating entanglement between qubit pairs.

According to the technique of the present disclosure, pulse optimization is performed by discretizing a continuous pulse into a pulse sequence of N pulses, each of duration dt (step 204). The pulse sequence may include discrete-time pulses with independently tunable amplitude within each time bin dt. Each of the single-qubit control pulses is represented by a pulse sequence PS₁ of the N pulses and each of the two-qubit interaction pulses is represented by a pulse sequence PS₂ of the N pulses (step 206). The pulse sequence of the single-qubit control pulse is represented by real and imaginary components of the time-dependent complex amplitudes dₖ(t), and the pulse sequence of the control two-qubit interaction pulses is represented by the time-dependent complex amplitudes u_{{k,l}}(t). Considering a cost function ƒ_{C}( [symbol] ) for a selected variational quantum algorithm to be performed by the quantum computing system, where [symbol] is a predefined vector of pulse parameters, the above-described discretizing results in representing this vector of pulse parameters, [symbol] , as a multi-parameter vector across multiple pulse sequences of the single-qubit control pulses and two-qubit interaction pulses (step 208).

Then, the values of the pulse parameters of the vector, \vec{θ}, undergo freestyle optimization (step 210) by iteratively varying these values (starting from initial values) while evaluating the cost function ƒ_{C}( [symbol] ) by analyzing measured data indicative of measurements of the q qubits in the quantum computing system (being provided by readout circuitry 114 of the system 100 in FIG. 1) until convergence criteria are met.

The initial values for the pulse parameters may be set to zero, corresponding to an initial computational basis state of the quantum computing system.

Optimizing values of the pulse parameters utilizes iterative pulse optimization. To this end, a gradient-free optimizer can be used. Such a gradient-free optimizer may be Constrained Optimization by Linear Approximation (COBYLA). Alternatively, a gradient-based optimizer can be used, e.g., where gradients are computed using a parameter-shift rule adapted for pulse parameters.

The pulse parameters at each time bin are independently optimized as free parameters to obtain a minimized cost function ƒ_{C}( [symbol] ), subject only to physical amplitude constraints |dₖ(t)|²≤1 and |u_{{k,l}}(t)|²≤1. By this, an optimized representation [symbol] of the vector of pulse parameters corresponding to the minimized cost function ƒ_{C}( [symbol] ) is provided (step 212).

The convergence criteria may be defined as one of the following: the cost function ƒ_{C}( [symbol] ) changing by less than a predetermined threshold between consecutive iterations; or achieving a target accuracy for the cost function; or reaching a maximum number of iterations. Considering for example, the cost function ƒ_{C}( [symbol] ) representing a molecular groundstate energy of a chemical system, where the convergence criteria is defined by achieving a target accuracy for the cost function, the target accuracy is a chemical accuracy, which may be defined as an energy deviation of ±0.0016 Ha (Hartree) from a Full Configuration Interaction (FCI) energy.

Thus, the above-described discretization-based technique of the present disclosure grants optimal flexibility in shaping the pulse, without the need to adhere to any predefined function, while accounting directly for dedicated two-qubit pulse channels, thereby facilitating natural and direct entanglement generation, being more compatible with real devices.

The duration dt of each pulse in the pulse sequence may be selected based on a characteristic control timescale of the quantum computing system, and may be between 0.1 ns and 100 ns. Considering for example the superconducting qubit system, the pulse duration dt may be approximately 0.22 ns.

The number N of pulses in the pulse sequence may be between 1 and 100. The number N of pulses and/or the pulse duration dt may be optimized to provide an optimized total pulse duration N×dt to be less than a coherence time of the quantum computing system. The total pulse duration N×dt may be selected to approach a quantum speed limit for state preparation in the quantum computing system.

The quantum computing system may be configured with all-to-all connectivity topology for connecting the q qubits, the number of the two-qubit interaction channels being q(q-1) and the total number of channels being q² (q²=q+q(q-1)). Alternatively, the quantum computing system may be configured with a linear topology for connecting the q qubits, thereby reducing the number of total channels and reducing complexity. In the linear topology, only adjacent qubits can interact, such that for q qubits in a line, the number of two-qubit interaction channels (i.e., directions of control) is 2(q-1) (considering that for q qubits in a line, there are (q-1) connections) and the total number of channels is 3q-2 (3q-2=q+2(q-1)). For example, utilizing the linear topology for calculating the ground state energy of the LiH molecule using 3 qubits requires 3 single-qubit channels and 2 bidirectional two-qubit channels, amounting to a total of 7 channels, as will be described below.

The two-qubit interaction channels may be bidirectional, including a first interaction channel for qubit k interacting with qubit l and a second interaction channel for the qubit l interacting with the qubit k. Alternatively, the two-qubit interaction channels may be unidirectional.

As described above, the number of qubits may be equal or higher than 2. For example, the number of qubits may be between 2 and 10, e.g., three qubits.

The measurements of the q qubits (performed by the readout circuitry 114) and analysis of the measured data (typically performed by the classical controller 102) may include errors evaluation/measurements based on measuring expectation values of observable operators. The observable operators may include at least Pauli \hat{Z} and \hat{X} operators.

Generally, the errors of the pulse optimization technique, that might not allow reaching c.a. on the real device, may be associated with various sources including statistical shot noise; leakage (i.e., arising from coupling to states outside a computational subspace of the qubits); and measurements-induced errors. These are specifically addressed further below.

More specifically, the technique of the present disclosure includes monitoring leakage errors arising from coupling to states outside a computational subspace of the qubits by direct measurement via IQ discrimination to different quantum states, e.g., |0>, |1>, |2> states. The quantitative analysis shows ~2% leakage at maximum. Four-level simulations including 13> state supported the finding that a single pulse of duration 1dt(0.222 ns) recovers the groundstate of H₂ to good accuracy and that the leakage is minimal.

The evaluation of the cost function (steps 210 and 212 in FIG. 2) may be performed as follows: the pulse sequence defined by current values of 0′ is applied to the quantum computing system, which performs multiple measurement shots on the q qubits, and expectation values are calculated/extracted from the measurement results (measured data), and the cost function ƒ_{C}( [symbol] ) is computed from the expectation values. The number of the multiple measurement shots may be between 10² and 10⁶.

As noted above, the pulse parameters that are involved in the optimization procedure for the given quantum computing system related data sequence include the duration dt of the pulse resulting from discretization, time intervals between the pulses in the sequence of pulses, and the number of pulses in the sequence, as well as the pulse shape. It should be noted that the duration dt, timing, and pulse shape parameters may be modified to meet hardware-specific constraints of the quantum computing system.

As noted above, the quantum computer system that can advantageously incorporate the pulse optimization technique of the preset disclosure may be: a superconducting quantum computing system, in which the single-qubit control channels are microwave drive channels and the two-qubit interaction channels are cross-resonance control channels; or a trapped ion quantum computing system, in which the single-qubit control channels are laser beams addressing individual ions and the two-qubit interaction channels implement Mølmer-Sorensen gates through laser-mediated phonon coupling; or a neutral atom array quantum computing system using Rydberg atoms, where the single-qubit control channels control Rabi frequency Ω(t) for individual atoms and the two-qubit interaction channels control detuning Δ(t) to modulate Rydberg blockade interactions; or is a quantum dot spin qubit system, where the single-qubit control channels are voltage-controlled gates for individual spin rotations and the two-qubit interaction channels control exchange coupling J(t) between adjacent quantum dots.

The time-dependent complex pulse amplitudes may be controlled through any one of the following: amplitude modulation and phase modulation for superconducting qubits; laser intensity and frequency detuning for trapped ions or neutral atoms; or voltage amplitude and timing for quantum dots.

As described above and will be exemplified more specifically further below, the technique of the present disclosure provides for pulse optimization enabling to obtain a minimized cost function subject only to physical amplitude constraints. The physical amplitude constraints may be defined by platform-specific maximum control amplitudes determined by hardware limitations of the quantum computing system.

In the following, the pulse Hamiltonian in superconducting qubits is described. This is the time-dependent quantum mechanical evolution of a qubit system during the application of control pulses, i.e., mathematical framework for how pulses manipulate quantum states.

In superconducting setting, the Hamiltonian over N_{q} qubits is given by [29]:

$${H}_{full} = {\sum }_{k}^{{N}_{q}} [ {\hat{H}}_{Drive}^{( k )} + {\sum }_{l ∈ {𝒩}_{k}} ( {\hat{H}}_{Control}^{( k , l )} + {\hat{H}}_{CR}^{( k , l )} ) ] , \qquad ( 1 )$$

where

$${\hat{H}}_{D r i v e}^{( k )}$$

is a tunable single-qubit drive/control channel for the k'th qubit,

$${\hat{H}}_{C ontrol}^{( k , l )}$$

is a tunable two-qubit interaction channel of qubit k over qubit l,

$${\hat{H}}_{CR}^{( k , l )}$$

is the fixed cross-resonance Hamiltonian, which generates an uncontrolled interaction between qubits k and l, and [symbol] accounts for all qubits connected to the k'th qubit in the device topology.

The single qubit control channels

$${\hat{H}}_{D r i v e}^{( k )}$$

and the two-qubit interaction channels

$${H}_{Control}^{( k , l )}$$

can be tuned via user-defined time-dependent complex functions dₖ(t) and u_{k,l}(t), respectively, whose magnitude is restricted to |dₖ(t)|²≤1, and |u_{k,l} (t)²≤1, to ensure physical limits.

The single-qubit Hamiltonian,

$${\hat{H}}_{Drive}^{( k )} ,$$

denoted as the “Drive Hamiltonian”, is given, for the k'th qubit, by [29]:

$${\hat{H}}_{D r i v e}^{( k )} / ℏ = - {ω}_{k}^{z} {\hat{σ}}_{k}^{z} + {Ω}_{k} {D}_{k} ( t ) {\hat{σ}}_{k}^{x} , \qquad ( 2 )$$

where

$${\hat{σ}}_{k}^{α}$$

are the Pauli operators,

$${ω}_{k}^{z}$$

is the qubit's energy gap, Ωₖ is the coupling constant, and,

$${D}_{k} ( t ) = Re [ {e}^{i {ω}_{k}^{d} t} {d}_{k} ( t ) ] \qquad ( 3 )$$

is the qubit's drive channel, where

$${ω}_{k}^{d}$$

is the drive frequency and dₖ(t) ∈ [symbol] is a user-defined time-dependent function, e.g. a Gaussian pulse.

To adhere to physical limitations, the drive function's magnitude obeys |dₖ(t)|²≤1. The drive's frequency,

$${ω}_{k}^{d} ,$$

is also user-controlled and can generally be tuned. Here the default frequency value is used, which is set to the qubit's energy gap,

$${ω}_{k}^{z} .$$

The complex nature of dₖ(t) allows the implementation of the R_{z} rotation virtually by applying a time-dependant phase to the user-defined time-dependent complex function for the single-qubit control channel dₖ(t).

The interaction with each neighboring qubit l is generated by the following cross-resonance Hamiltonian:

$${H}_{C R}^{( k , l )} / ℏ = {J}_{k l} ( {\hat{σ}}_{k}^{+} {\hat{σ}}_{l}^{-} + {\hat{σ}}_{k}^{-} {\hat{σ}}_{l}^{+} ) , \qquad ( 4 )$$

where Jₖₗ is the coupling constant for qubit k and l. User-defined control over the two-qubit interactions is gained via the control Hamiltonian

$${\hat{H}}_{C o n trol}^{( k , l )} / ℏ = {Ω}_{k} {U}_{k , l} ( t ) {\hat{σ}}_{k}^{x} , \qquad ( 5 )$$

with

$${U}_{k , l} = Re [ {e}^{i ( {ω}_{k}^{d} - {ω}_{l}^{d} ) t} {u}_{k , l} ( t ) ] , \qquad ( 6 )$$

where u_{k,l} (t) ∈ [symbol] is a user-defined time-dependent function for the interaction channel of qubits k and l, in an analogy to dₖ(t) in the single qubit's control channel, and the magnitude of the control function satisfies a condition |u_{k,l}(t)|²≤1.

One of the possible industrial applications of the technique of the present disclosure is determination of a molecular groundstate energy of a chemical system. To this end, let us consider that the cost function ƒ_{C}( [symbol] ) for a selected variational quantum algorithm to be performed by the quantum computing system represents a molecular groundstate energy of a chemical system.

The variational quantum eigensolver (VQE) algorithm marked the beginning of VQAs dedicated to finding the groundstate energy of chemical systems. In the present disclosure, the pulse optimization scheme is described based on the Variational Quantum Selected Configuration Interaction (VQ-SCI) method. This technique has been recently proposed as a qubit-efficient alternative algorithm, which serves the same purpose as in the VQE but with fewer qubits, by adopting a different encoding scheme [26]. More specifically, this scheme is based on first, rather than second, quantization, where the computation is carried out on the basis of Slater determinants (or configurations). Similar to classical selected configuration interaction (SCI) schemes, and contrary to the full configuration interaction (FCI) method, which accounts for all possible Slater determinants, the VQ-SCI is based on selecting only the most significant ones. This reduces computational burden with a controlled compromise in accuracy [28].

The pulse optimization scheme of the present disclosure is demonstrated here based on the VQ-SCI method because of the following: First, VQ-SCI is less susceptible to noise, due to the qubit reduction. For the H₂ and LiH molecules it requires just 1 and 3 qubits, respectively, instead of 2 and 4 qubits in VQE [26]; and Second, VQ-SCI conveniently sets the Hartree-Fock (HF) solution as the all-zero state |0 . . . 0 [symbol] ^{└q}, whereas VQE requires applying an extra X gate to as many qubits as the number of active electrons, a straightforward but time-consuming (about 71 ns) and noise-introducing process. These advantages of demonstrating the pulse optimization scheme through the VQ-SCI method provide for short and accurate calculations.

As noted above, the freestyle pulse optimization scheme of the present disclosure, is based on the discretization of the continuous pulse into a pulse sequence of N small pulses each of duration dt, where each small pulse has a tunable complex amplitude that is optimized individually. This discretization grants optimal flexibility in shaping the pulse, without the need to adhere to any predefined function. However, in contrast to the earlier discretization-based approach [24], the scheme of the present disclosure accounts directly for dedicated two-qubit interaction channels, thereby facilitating natural and direct entanglement generation, being more compatible with real devices. The technique of the present disclosure accounts for one single-qubit control channel per qubit and two directed two-qubit interaction channels per qubit pair, amounting to a total of q+q(q −1)=q² complex pulse channels, for q qubits in an all-to-all topology. For N time-bins, the number of tunable real parameters is given by 2Nq².

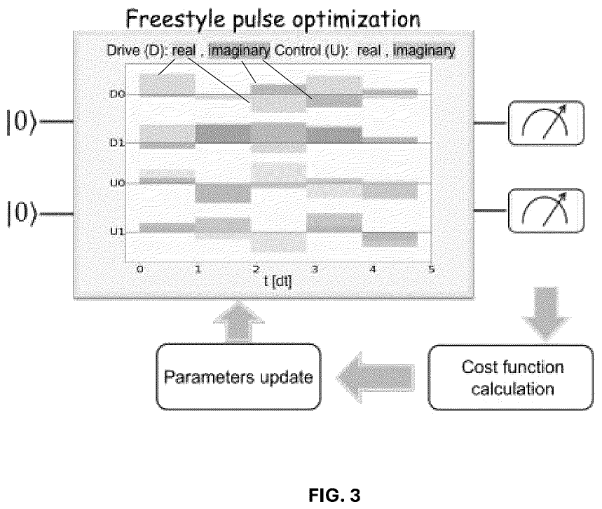

The freestyle pulse optimization scheme is exemplified in FIG. 3 for a circuit with q=2 qubits and N=5 time-bins and is outlined in Algorithm 1. It begins with initializing the pulse Hamiltonian of Eq. (1) to (6), with a fixed set of discrete parameters, where the pulse amplitude of each channel is assigned an individual parameter per time bin. Then, as typically done in VQAs, the circuit (pulse application to qubit chip) is executed, and the qubits are measured to evaluate the problem-dependent cost-function.

The pulse parameters are then tuned/optimized. This can be implemented by updating the pulse parameters by the classical controller 102 based on measurement results (measured data) provided by the readout circuitry 114 of the quantum computing system. The classical controller 102 updates operates to steer the cost function towards a global minimum, repeatedly, until convergence. The pulse duration accounts only for the state preparation (without measurement) and is given by Ndt, where dt is the time length of each time bin.

Algorithm 1: Freestyle pulse optimization

```
Input: q, N, f_{C}(\vec{θ}) // \#qubits, \#time-bins, cost
Output: \vec{θ}*, f_{C} (\vec{θ}*) // optimal parameters and cost
Initialize: \vec{θ}
while not converged do
    | Run on quantum computer and sample to assess
    | Update tunable parameters \vec{θ} via classical optimization
end
return {\vec{θ}, f_{C}(\vec{θ})}
```

In the following, the freestyle pulse optimization is illustrated on determining the groundstates of H₂ and LiH, within the VQ-SCI framework. The inventors performed both noisy simulation and real-hardware experiments on the ibmq jakarta device. The noisy simulations, using IBM's “qiskit-dynamics” package, were based on the machine's T1 and T2 values (relaxation and dephasing times as benchmarked in the calibration), and connectivity map. Statistical shot-noise was avoided by simulating the state-vector of the system.

In real hardware executions, every pulse duration is a multiple of 16 dt and at least 64 dt long. To conform to these constraints, the pulse with zero amplitudes were padded whenever required. Specifically, the inventors employed ‘right’ padding by appending zero amplitude pulses to the end of the pulse, effectively delaying its stopping time. This approach has shown marginally quicker convergence in simulations compared to ‘middle’ and ‘left’ padding methods.

The equilibrium interatomic distance is taken to be 0.745 Å for H₂ and 1.5 Å for LiH. The pulses were initialized with zero amplitudes, recovering the HF solution, and employed basic readout error mitigation techniques [31] to improve fidelity. As noted above, to accommodate IBMQ's hardware constraints on pulse duration, the pulse was padded with zero amplitudes whenever needed. Finally, the gradient-free constrained optimization by linear approximation (COBYLA) optimizer was used. COBYLA utilizes an adjustable hyperparameter known as rhobeg, which corresponds conceptually to the initial learning step-size. The inventors have found empirically through noisy simulations, that in the H₂ molecule, for interatomic distances up to 1.5° A, the optimal rhobeg value was 0.05, whereas for larger distances it was 0.1. For the equilibrium of LiH (1.5° A) the optimal value on noiseless simulation was 0.8. In all cases, the pulse was initialized to zero amplitudes, which recovers the HF solution. Finally, to enhance the fidelity of the results, the inventors employed basic readout error mitigation techniques [31].

In the following, the simulations and real measurements for determining the groundstate of H₂ are described.

The two-qubit Ansätze for H₂ in VQE typically have a pulse duration of hundreds of nanoseconds [20]. Employing the VQSCI method enables the H₂ molecule to the exact FCI energy value with a single-qubit Ansatz circuit consisting of a single Ry rotation (gate) [26], which has a fixed pulse duration of 320 dt≈71 ns on IBMQ devices, regardless of the desired rotation angle. Next, noisy simulation and real-hardware VQSCI calculations are presented for the H₂ molecule with pulses ranging from 0.22 ns to 2.22 ns on ibmq_jakarta, where the minimal timebin was dt=0.22 ns. It should be noted that imperfections in experimental equipment result in pulse smearing, effectively extending the duration of a ‘pulse’ beyond the ideal 1 dt.

The SCI Hamiltonian matrix of the H₂ molecule, in the equilibrium interatomic distance of 0.745 Å, is given by:

$${\hat{M}}_{CI} = ( \begin{matrix}- 1.8267 & 0.1814 \\ 0.1814 & - 0.2596\end{matrix} ) , \qquad ( 7 )$$

decomposed to the following sum of Pauli operators:

$${\hat{M}}_{CI} = - 1 \text{.0431} \hat{I} - 0.7835 \hat{Z} + 0.1814 \hat{X} \qquad ( 8 )$$

whose groundstate is given by the single qubit state:

$$\vert Ψ 〉 = - 0.9935 \vert 0 〉 + 0.1135 \vert 1 〉 , \qquad ( 9 )$$

corresponding to the lowest eigenvalue of −1.8474 Ha. After adding the nuclear repulsion energy (0.7103 Ha), the total SCI groundstate energy amounts to −1.1371 Ha, identical in this case to the FCI groundstate energy. Details of representing the H₂ molecule in the VQ-SCI approach are generally known [26].

The following is the description of the groundstate energy calculation of the hydrogen molecule using a single qubit:

Step I—Selecting the Slater determinant:

The H₂ molecule (N=2 electrons) has M=4 spin-orbitals in the sto-3g basis set, which result with DFCI=4 possible spin-restricted configurations:

$${Φ}_{0} = S D \{ {σ}_{1 s , g ↓} , {σ}_{1 s , g ↑} \} , {Φ}_{2} = S D \{ {σ}_{1 s , u ↓} , {σ}_{1 s , g ↑} \}$$

$${Φ}_{1} = S D \{ {σ}_{1 s , u} , {σ}_{1 s , u ↑} \} , {Φ}_{3} = S D \{ {σ}_{1 s , sl} , {σ}_{1 s , u ↑} \}$$

where each spin-orbital takes the gerade (g) or the ungerade (u) spatial symmetry.

In this simple case the most dominant Slater determinants may be selected using solely symmetry considerations: the exact groundstate of H₂ is known to be of the gerade symmetry, and hence cannot consist of Slater determinants that do not obey this symmetry. In particular, single excitation determinants with ungerade symmetry must be excluded [2]. This leaves only two allowed Slater determinant to be selected: Φ₀ and Φ₁, where Φ₀ is the single-determinant HF solution and Φ₁ is the double excitation state relative to it. In this case the SCI groundstate is hence identical with the FCI groundstate.

Step II—Ordering the Slater determinant:

In this step each Slater determinant is mapped to a particular computational state. Here, the direct mapping is performed:

$${Φ}_{0} \to \vert 0 〉 , {Φ}_{1} \to \vert 1 〉$$

with which the H₂ groundstate is given by

$$ψ = {c}_{0} {Φ}_{0} + {c}_{1} {Φ}_{1} = {c}_{0} \vert 0 〉 + {c}_{1} \vert 1 〉 , {\vert {c}_{0} \vert}^{2} + {\vert {c}_{1} \vert}^{2} = 1$$

Step III-Constructing the 2-dimensional SCI matrix:
Constructing the 2-dimensional SCI matrix \hat{M}_{CI}, is performed by classical methods. Here, we used psi4 [60] to calculate it, as follows (reaching Eq. (7) above):

$${M}_{G} = [ \begin{matrix}〈 {Φ}_{0} \vert ℋ \vert {Φ}_{0} 〉 & 〈 {Φ}_{0} \vert ℋ \vert {Φ}_{1} 〉 \\ 〈 {Φ}_{1} \vert ℋ \vert {Φ}_{0} 〉 & 〈 {Φ}_{1} \vert ℋ \vert {Φ}_{1} 〉\end{matrix} ] = [ \begin{matrix}- 1.8267 & 0.1814 \\ 0.1814 & - 0.2596\end{matrix} ] = [ \begin{matrix}〈 0 \vert ℋ \vert 0 〉 & 〈 0 \vert ℋ \vert 1 〉 \\ 〈 1 \vert ℋ \vert 0 〉 & 〈 1 \vert ℋ \vert 1 〉\end{matrix} ]$$

where H is the Hamiltonian of the H₂ molecule, evaluated at the equilibrium bond length of 0.745 Ang and the last equality term stems from the above mapping.
Step IV-Encoding the SCI matrix to Pauli operators:

Given the SCI matrix \hat{M}_{CI}, in the computational basis, it is next translated to a linear combination of Pauli operators (leading to Eq. (8) above):

$${\hat{M}}_{CI} = - 1.8267 \vert 0 〉 ( 0 \vert + 0.1814 \vert 0 〉 ( 1 \vert + 0.1814 \vert 1 〉 ( 0 \vert - 0.2596 \vert 1 〉 ( 1 \vert = - 1.0431 \hat{I} - 0.7835 \hat{Z} + 0.1814 \hat{X}$$

While this step is conceptually simple, it adds a large classical computational overhead.
Step V—Finding the groundstate of the SCI matrix:

Once the H₂ SCI matrix is decomposed to Pauli operators, its lowest eigenvalue is found via the standard variational quantum scheme. Since a single qubit is used and since the SCI matrix and hence the groundstate are both real, the Anzats circuit consists only of a single-qubit Ry rotation:

$$ψ ( θ ) = {R}_{y} ( θ ) \vert 0 〉 = cos ( \frac{θ}{2} ) \vert 0 〉 + sin ( \frac{θ}{2} ) \vert 1 〉$$

Finally, it is noted that in this example the groundstate energy of the \hat{M}_{CI} matrix is given by

$${ϵ}_{0} = - 1.8474 ,$$

which, together with the nuclear repulsion of 0.7103 Ha reaches a total groundstate energy of −1.1371 Ha. The associated groundstate is given by (as in Eq. (9) above)

$$\vert Ψ 〉 = - 0.9935 \vert 0 〉 + 0.1135 \vert 1 〉$$

which corresponds to 0=6.0557 rad in the above equation.

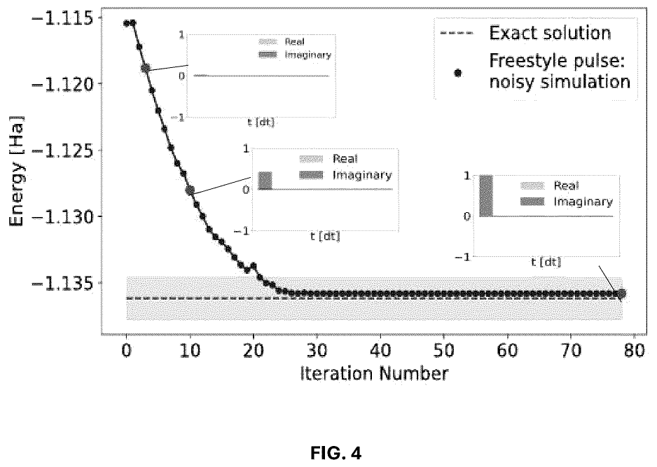

Referring to FIG. 4, the total groundstate energy of the H₂ molecule at the equilibrium distance is illustrated, being calculated using the shortest pulse duration of 1dt=0.22 ns through noisy simulations, plotted against the number of iterations. The groundstate total energy is shown per iteration (blue dots), resulting pulses are depicted at three distinct iterations (designated by red dots). In the figure, the dashed green line and the green area mark the FCI energy and the c.a. region.

It is seen that the iterative process converges rapidly to the c.a. region, defined as ±0.0016 Ha from the FCI energy. The inventors focus on pulses from three different iterations (red dots). It is seen that only the imaginary part of the pulse's amplitude increases with the iterative process.

Analysis of the iterative pulse optimization may be performed in a rotating frame or interaction picture corresponding to the quantum computing system. For the quantum computing system operating in a rotating wave approximation, a real component Re[dk(t)] of the single-qubit control pulse amplitude generates rotation around a first axis of a Bloch sphere representation; and an imaginary component Im[dk(t)] of the single-qubit control pulse amplitude generates rotation around a second orthogonal axis of the Bloch sphere representation.

In the specific example described above, showing that only the imaginary part of the pulse's amplitude increases with the iterative process, these dynamics can be understood within the rotating wave approximation (RWA) frame. In single-qubit systems, it is often helpful to consider the single qubit's drive channel under the rotating-wave approximation (RWA):

$${\hat{H}}_{D r i v e}^{R W A} / ℏ = - {δ}_{k} {\hat{σ}}_{k}^{z} + {Ω}_{k} ( Re [ {d}_{k} ( t ) ] {\hat{σ}}_{k}^{x} + Im [ {d}_{k} ( t ) ] {\hat{σ}}_{k}^{y} ) \qquad ( 10 )$$

where δₖ is the difference between the frequencies of the qubit and the pump, Ωₖ is the coupling constant, and

$${\hat{σ}}_{k}^{α}$$

is a Pauli operator with α ∈ {x, y, z}acting on qubit k.

In this framework, the real and imaginary parts of d(t) can be seen as rotations around the x and y-axis, respectively; This explains the H₂ results: since a single R_{y} gate alone is sufficient for accurately finding the groundstate of H₂ [26], the final pulse is expected to be mostly imaginary, as indeed observed in FIG. 4.

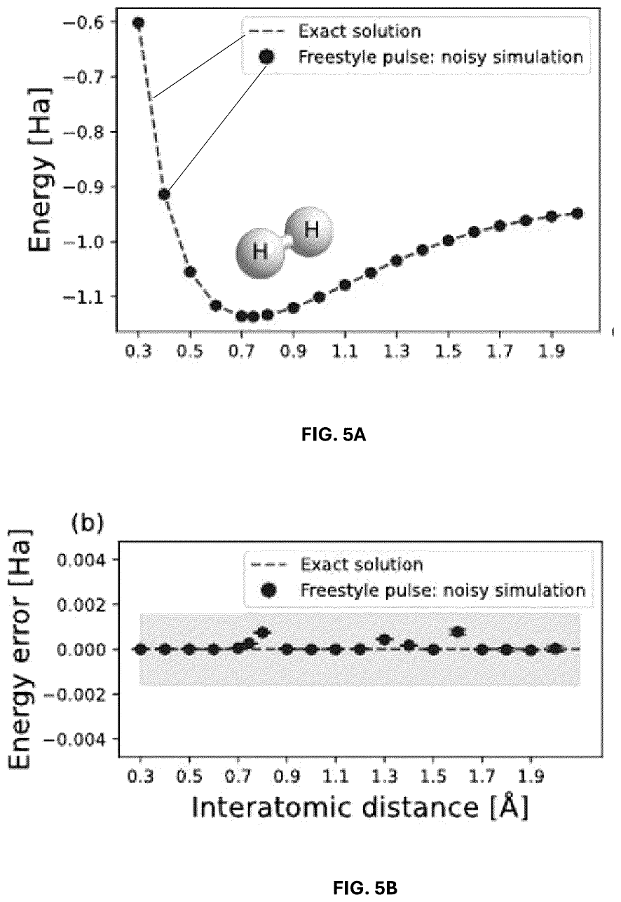

Reference is made to FIGS. 5A and 5B, where FIG. 5A depicts the attained H₂ groundstate total energy per interatomic distance, and FIG. 5B is a zoom-in view of energy error relative to exact FCI. The dashed green line and the green area mark the FCI energy and the c.a. region. The results are thus shown to be within the c.a. region across all distances.

At each interatomic distance, the simulations began with the shortest possible pulse duration/time bin (1 dt) and the time bin was incrementally extended by one dt at a time until reaching c.a.

It is noted that repeating the iterative pulse optimization for multiple interatomic distances, described in FIGS. 5A and 5B, actually corresponds to determining a dissociation curve of the molecule, since the range from approximately 0.5 Å to 2.0 Å covers the dissociation region from near-equilibrium (0.745A) to stretched bond configurations. This demonstrates that the technique of the present disclosure may be applied not only at equilibrium geometry, but throughout the potential energy surface.

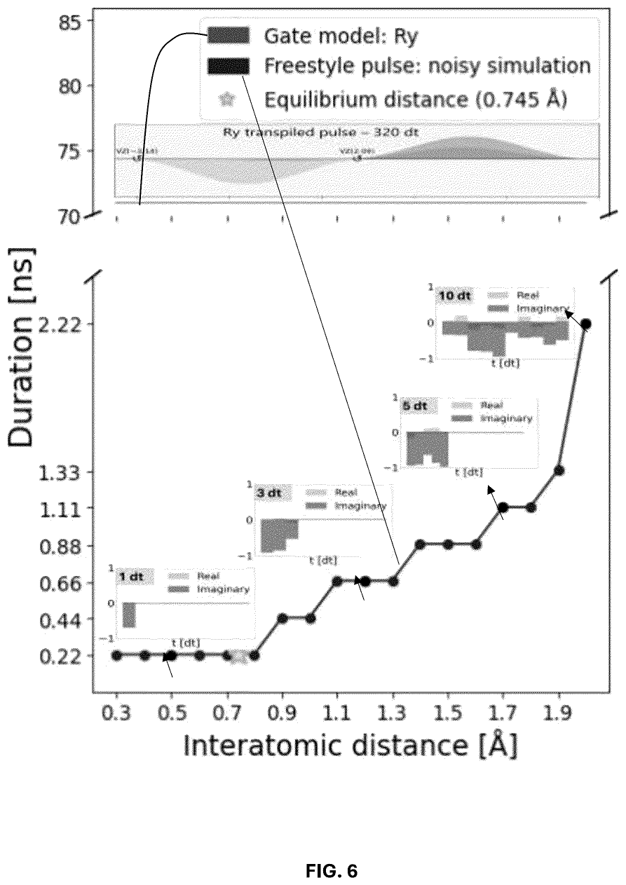

Reference is made to FIG. 6 which depicts the minimal pulse duration required for the gated circuit/model and the freestyle pulse method to reach c.a., per interatomic distance. In the gated circuit, a single Ry gate was used, resulting in a fixed pulse duration of ≈71 ns (red line) regardless of distance. In contrast, the freestyle method requires a maximum of ≈2.22 ns at a bond length of 2 Å, and as little as 1dt=0.22 ns at equilibrium, showcasing a significant reduction.

Regarding the real-hardware, the following should be noted. The freestyle pulse scheme was run on the ibmq_jakarta device for the H₂ at the equilibrium distance, using 10⁵ shots. A single pulse of 1 dt duration, initialized to zero, was optimized. Four such experiments were conducted. The best execution resulted in an FCI deviation of 0.2 mHa, reached at the 20th iteration.

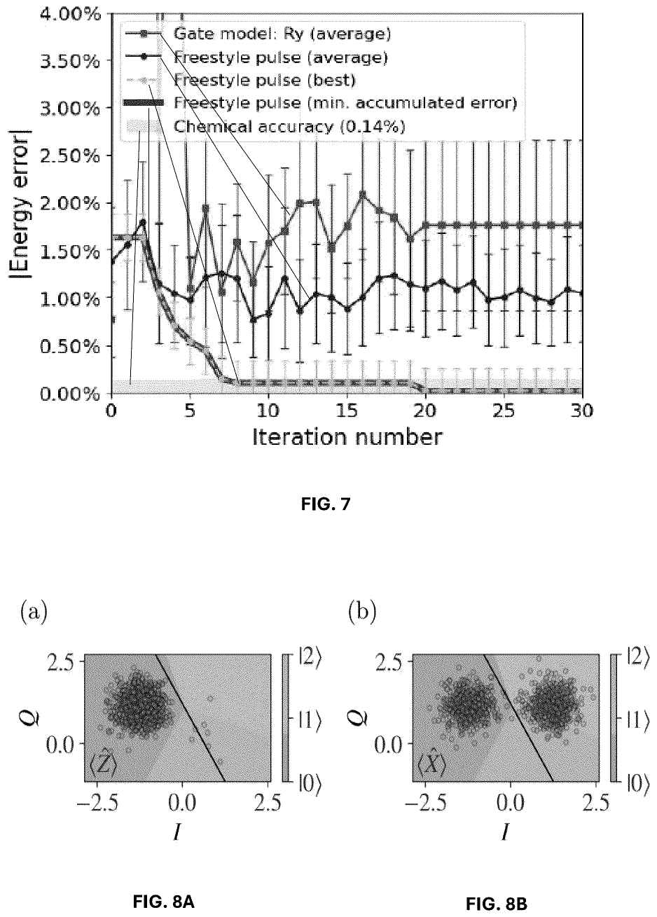

FIG. 7 shows real-hardware (ibmq_jakarta) results for H₂ at equilibrium distance, wherein percentage error deviation from exact FCI energy is shown per iteration: averaged over 3Ry gate experiments (red), averaged over 4 freestyle 0.22 ns pulse experiments, and a single freestyle pulse experiment (cyan). The dark green curve depicts the minimal accumulated error at each iteration, and the light green area marks the c.a. region. The absolute FCI error deviation |(Eᵢₜₑᵣ−E_{FCI})/E_{FCI}|, per iteration, in percentage is shown. The figure shows the average of the different freestyle pulse experiments (solid blue), along with the best execution (dashed cyan), shown to converge towards the c.a. region. This is highlighted by the corresponding minimal accumulated error curve (dark green). The error bars in the average curve present the standard error of the mean (SEM), whereas, for the single execution curve, the error bars correspond to the X-Z measurement errors.

FIG. 7 further shows the average error of three different Ry calculations (solid red). To facilitate a fair comparison, both the Ry and freestyle pulse experiments were conducted within the VQ-SCI scheme, on the least noisy qubit of the ibmq-jakarta device, using identical numbers of shots and error mitigation, with the Ansatz being the only variable. It is seen that the gated Ry experiments converged to a higher average absolute error deviation of about 1.76% from the FCI energy. Moreover, in contrast to the freestyle pulse results, hardly any Ry iteration entered the c.a. region. The pulse calculations reduced the averaged error significantly to ≈1%.

Table 1 presents the real-hardware pulse optimization results for H2 groundstate calculation. Data in the Table 1 shows the freestyle pulse duration and the FCI error deviation in comparison to previous real-hardware pulse optimization results [18] and [21], where VQE calculations with two qubits were performed. Per study, the table specifies: qubits number, utilized method, interatomic distance (i.a.d), pulse duration, and the FCI energy deviation.

TABLE 1

| | #q | alg. | i.a.d. [Å] | T[ns] | Δ_{FCI} [mHa] |
|---|---|---|---|---|---|
| NAPA [18] | 2 | VQE | 0.75 | 71 | 37 |
| PANSATZ [21] | 2 | VQE | 0.7 | 40 | 0.7 |
| Gate model: R_{y} | 1 | VQ-SCI | 0.745 | 71 | 1.32 ± 0.66 |
| Freestyle (this work) | 1 | VQ-SCI | 0.745 | 0.22 | 0.2 ± 2.7 |

The technique of the present invention provided optimized pulse shape, in particular, optimized pulse duration of 1dt≈0.22 ns, which is more than two orders of magnitude shorter than previously achieved. Remarkably, using the exact device parameters, shows that the experimental pulse duration obtained using the technique of the present disclosure nearly matches the theoretical QSL. This limit represents the minimal time required for a quantum system's evolution from a given initial state to a desired target state. Although the QSL may be surpassed, it provides an order-of-magnitude benchmark for the minimal pulse duration, serving as a valuable figure of merit.

It can be noted that the freestyle pulses provided in the system of the present disclosure may not always reach c.a. on the real device. This may be associated with one or more of the following: statistical shot noise; leakage; and/or measurements-induced errors. Possible shot noise factor was excluded by trial—the number of shots was increased up to 6×10⁵ and no improvement was observed. As for leakage, it is typically associated with short, intense, and abrupt pulses leading to higher energy level occupation. However, a detailed analysis described below, shows that in the specific case, where the solution is predominantly in the |0> state, leakage is not a major factor. Lastly, measurement errors were examined. Small deviation in \hat{Z} measurements were noted, whereas I measurements, involving an extra Hadamard transformation, exhibited a significant error. The inaccuracies in the calculations are attributed to this significant error.

Short and abrupt pulses are susceptible to leakage because the Fourier decomposition of such pulses yields a broad spectrum of frequency components, increasing the likelihood of off-target transitions. To check if leakage affected the calculations described above, the experimental raw measurements described above were analyzed, namely the undiscriminated I and Q data points

IBM's standard calibration process was employed, to discriminate the I and Q data points to different quantum states, namely, |0 [symbol] ,|1 [symbol] and |2 [symbol] to identify leakage. This process is composed of standard frequency spectroscopy for identifying transition frequencies and Rabi spectroscopy for calibrating transition pulse amplitudes. Now regions in the I and Q planes can be defined to represent the different quantum states. To that end, the linear discriminant analysis (LDA) class in “scikitlearn” was used.

Then, the I and Q measurements acquired at each iteration were classified to these three states for the final VQ-SCI iteration in the groundstate calculation of H₂. In this connection, reference is made to FIGS. 8A and 8B showing IQ measurement points, in the z and x basis, classified to the |0 [symbol] ,|1 [symbol] , and |2 [symbol] states. The measurements were done in the final H₂ VQ-SCI iteration. The I and Q data points are normalized by a factor of 10⁸. Each dot corresponds to a single measured shot on the quantum computer. In the figures, the solid line (black line) represents the classification to {|0 [symbol] and |1 [symbol] }. It is seen that in the \hat{Z}-measurement, see FIG. 8A, the leakage is negligible, whereas in the \hat{X}-measurements, see FIG. 8B, more IQ points are found in the |2) state region. Yet, their vast majority can be safely associated with the |1) state (one may consider using a different classifier, but LDA is sufficient, given the minor leakage). This hints that the effect of leakage in the calculation described above is negligible and is not the main source of error in real devices.

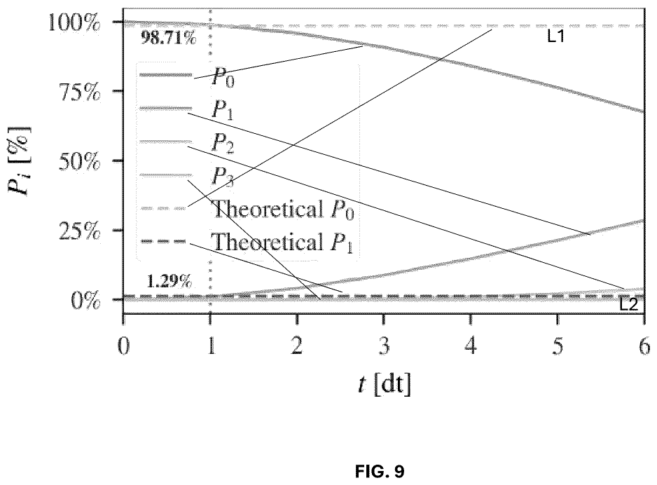

To further support the above demonstration, the dynamics of a—level system was simulated, undergoing a single pulse of maximal amplitude. Reference is made to FIG. 9 illustrating simulation of the evolution of the 4-level system, starting from the |0) state, under a constant pulse of maximal amplitude, as a function of time.

More specifically, FIG. 9 shows the probability of each state as a function of time, starting from the |0) state. It is seen that the probability P₀ of measuring the |0) state (purple curve) drops with time, whereas the probability P₁ of measuring the |1) state (red curve) increases with time, as expected. As a sanity check, FIG. 9 depicts in horizontal dashed lines L1 and L2 the expected probabilities of the |0) (light green line L1) and |1) (dark green line L2) states in the H₂ FCI groundstate, as given in Eq. (9) above. It is seen that a maximal amplitude pulse attains the required state after 1 dt, being in good correspondence with the classical simulation results, see FIG. 4.

The simulation shown in FIG. 9 is noisy, based on Jakarta's topology and noise model, and assuming “right-padding”. This simulation supports the finding that a single pulse of duration 1 dt (0.222 ns) recovers the groundstate of H₂ to good accuracy and that the leakage is minimal.

As for leakage, it is seen that the probability of measuring the |2 [symbol] state (probability curve P2, orange), increases very slowly with time, reaching only ~2% leakage to the |2 [symbol] state after 5 dt and that the probability of measuring the |3 [symbol] state (P3, cyan) remains negligible even after 6 dt. This is indicative of that even at maximum amplitude intensity a steady pulse experiences very little leakage after 1 dt. Moreover, with more typical amplitudes, of up to 30% of the maximal amplitude, much less leakage can be achieved.

For example, for the best iteration shown in FIG. 7 which has an amplitude of:

$$d ( 0 < t \leq 0.22 ns ) = - 0.07 - 0.266 i , \qquad ( 11 )$$

the expected leakage is practically zero, with merely 2.45-10⁻⁵%.

This analysis underscores the reliability of the experimental outcomes presented above, demonstrating that leakage, even under conditions of short and strong pulses, is minimal in the particular case, where the precise solution resides primarily in the |0) state (see Eq. (9) above).

Thus, the inventors demonstrated that shape-flexibility allows determining the groundstate energy of the H₂ and LiH molecules to high accuracy while significantly reducing pulse duration. Notably, c.a. for H₂ groundstate calculation was achieved on an actual device using its minimal pulse duration of 0.22 ns. This pulse duration may be regarded as the shortest FCI-level accurate groundstate preparation, ever realized on real quantum hardware, closely reaching the theoretical quantum speed limit.

Quantum speed limit (QSL) is the minimal time required for evolving a given initial state |ψ₀ [symbol] to a final state |ψ_{ƒ} [symbol] . While it is not a rigorous bound that cannot be violated, it gives an order of magnitude benchmark for the required time evolution.

Here the QSL is derived for the groundstate energy calculation of H₂, starting from the |0 [symbol] state. To that end, the QSL for transition between non-orthogonal states is given by:

$${τ}_{QSL} ≡ max ( α ( ε ) \frac{ℏ π}{2 \overline{E}} , β ( ε ) \frac{ℏ π}{2 Δ \overline{E}} ) , \qquad ( 12 )$$

where

$$\overline{E} = \frac{1}{T} {\int }_{0}^{T} E ( t ) dt \qquad ( 13 )$$

is the time average energy of the system, and

$$Δ \overline{E} = \frac{1}{T} {\int }_{0}^{T} \sqrt{{〈 ψ ( t ) \vert \hat{( H} ( t ) - E ( t ) )}^{2} \vert ψ ( t ) 〉} dt \qquad ( 14 )$$

is the time average energy variance of the system; where E(t) ≡ [symbol] ψ(t)|Ĥ(t)|ψ(t) [symbol] is the energy of a given state at the time t and where the Hamiltonian Ĥ(t) is shifted by the groundstate energy such that the lowest energy is 0. The α(ε) and β(ε) are functions of the distance ϵ between the initial and the final state, which is given by:

$$ε ≡ {\vert 〈 {ψ}_{0} \vert {ψ}_{f} 〉 \vert}^{2} . \qquad ( 15 )$$

The function α(ε) has no analytical expression, but it can be approximated by α(ε)≈β²(ε), where the β(ε) function is given by:

$$β ( ε ) = \frac{2}{π} arc cos ( \sqrt{ε} ) . \qquad ( 16 )$$

In the superconducting setting, there are two candidate frames for calculating the QSL, the lab frame:

$${\hat{H}}^{lab} ( t = 0 ) / ℏ = - {ω}_{z} {\hat{σ}}_{z} \qquad ( 17 )$$

$${\hat{H}}^{lab} ( t = dt ) / ℏ = - {ω}_{z} {\hat{σ}}_{z} + Re [ {e}^{- i {ω}_{z} d t} d ( t = d t ) ] Ω {\hat{σ}}_{x}$$

and the rotating-wave-approximation (RWA) frame:

$${\hat{H}}^{rwa} ( t = 0 ) / ℏ = - {δ}_{z} {\hat{σ}}_{z} \qquad ( 18 )$$

$${\hat{H}}^{rwa} ( t = dt ) / ℏ = - {δ}_{z} {\hat{σ}}_{z} + Re [ d ( t = d t ) ] Ω {\hat{σ}}_{x} + Im [ d ( t = d t ) ] Ω {\hat{σ}}_{y}$$

For each frame, two possible final states were considered: the theoretical groundstate, given in Eq. (9), and the best state reached experimentally by the inventors (corresponding to the cyan curve in FIG. 7). The experimental state was calculated by simulating the unitary evolution the qubit experienced, in both the lab and the RWA frames, based on the Hamiltonian parameters used in the experiment. Table 3 presents the parameters used to calculate the QSL.

TABLE 3

dt = 0.222 ns
Sz = 0.000 2πGHz
Q = 271.374 2πMHz
Re[d(t)] = −0.070
Im[d(t)] = −0.266

This resulted in the following experimental state for the lab frame:

$$\begin{matrix}\vert {ψ}_{e}^{lab} 〉 ≡ \vert ψ ( t = dt ) 〉 = {U}^{lab} \vert 0 〉 \\ = ( 0.9999 - 0.0001 i ) \vert 0 〉 + ( - 0.0072 - 0.0105 i ) \vert 1 〉\end{matrix} \qquad ( 19 )$$

and for the RWA frame:

$$\begin{matrix}\vert {ψ}_{e}^{rwa} 〉 ≡ \vert ψ ( t = dt ) 〉 = {U}^{rwa} \vert 0 〉 \\ = ( 0.9892 - 0.1036 i ) \vert 0 〉 + ( - 0.0973 - 0.037 i ) \vert 1 〉\end{matrix} \qquad ( 20 )$$

Table 4 summarizes the full calculations of the QSL for any combination of the frame and state, showing that the QSLs in the lab frame are.

$${τ}_{QSL , t}^{lab} = 0.033 ns , {τ}_{QSL , e}^{lab} = 0.034 ns , \qquad ( 21 )$$

whereas in the RWA, the QSLs are:

$${τ}_{QSL , t}^{rwa} = 0.243 ns , {τ}_{QSL , e}^{rwa} = 0.222 ns . \qquad ( 22 )$$

TABLE 4

| Frame | Final state | ε[× 10⁻²] | β[× 10⁻²] | α[× 10⁻²] | Ē[ℏMHz] | ΔĒ[ℏMHz] |
|---|---|---|---|---|---|---|
| Lab | theoretical | 98.70 | 7.26 | 0.53 | 56.11 | 545.66 |
| Lab | experimental | 99.98 | 0.81 | 0.01 | 0.68 | 60.50 |
| RWA | theoretical | 98.70 | 7.26 | 0.53 | 79.01 | 74.58 |
| RWA | experimental | 98.92 | 6.64 | 0.44 | 74.70 | 74.70 |

τ_{QSL}[ns]

| Frame | Final state | α(ε)ℏπ/(2Ē) | β(ε)ℏπ/(2ΔĒ) | ${τ}_{Q S L}^{max} [ d t ]$ |
|---|---|---|---|---|
| Lab | theoretical | 0.024 | 0.033 | 0.15 |
| Lab | experimental | 0.024 | 0.034 | 0.15 |
| RWA | theoretical | 0.017 | 0.243 | 1.10 |
| RWA | experimental | 0.015 | 0.222 | 1.00 |

It is seen that whether the experimental final state is used or the theoretical final state, the obtained QSLs are close in both frames. However, there is a difference of an order of magnitude

$$( {τ}_{QSL}^{rwa} \sim 10 {τ}_{QSL}^{lab} )$$

between the two frames. In the RWA frame, all the fast-oscillating terms are dropped, thus providing a stricter bound for the QSL. As can be seen, in all limits the results obtained in the present disclosure are in agreement with the QSL. Moreover, under the specific parameters of the experimental pulse, the QSL of the RWA for the resulting experimental state is exactly 1dt. This indicates that within the device constraints, the experiment using the methods of the present disclosure recovered the theoretical QSL.

To estimate the shortest possible time evolution on the same device (ibmq_jakarta), the calculation was repeated with the same experimental parameters, but this time with a maximal amplitude. The calculation showed that for such a setup the QSLs can be reduced to:

$${τ}_{{QSL}^{*} , t}^{rwa} = 0.067 ns , {τ}_{{QSL}^{*} , e}^{rwa} = 0.061 ns , \qquad ( 23 )$$

This is indicative of that, if the minimal time bin dt could be relaxed, the exact FCI groundstate for the H₂ molecule could be reached via a pulse of 0.067 ns. It should be noted that experimental dispersion and additional qubit l cavity modes limit the realistic bandwidth of an actual pulse, making this extremely short driving unrealistic, although an important theoretical order-of-magnitude in understanding many-body control limitations.

In the following, the simulations and real measurements for determining the groundstate of LiH are described.

The freestyle pulse method of the present disclosure was assessed using classical simulations on multi-qubit circuits by computing the groundstate energy of the LiH molecule at its 1.5 Å equilibrium geometry, using the VQSCI scheme with three qubits [26]. In this geometry, the FCI energy of LiH is given by −7.882362 Ha, and the corresponding SCI energy, using 8 configurations, is −7.881566 Ha [26]. Moving beyond the single qubit regime makes use of the two-qubit control channels, which directly modulate the entanglement between qubits. Since generating entanglement typically requires more time, and in order to facilitate the pulse search, a total duration of ~200 ns was set.

More specifically, the LiH on the equilibrium of 1.5 Å can be described by the following SCI Hamiltonian matrix [26]:

$$( \begin{matrix}- 8.922 & 0.123 & 0.033 & 0.033 & 0. & 0. & 0.012 & 0.024 \\ 0.123 & - 7.819 & - 0.025 & - 0.025 & - 0.031 & - 0.031 & 0.026 & 0.019 \\ 0.033 & - 0.025 & - 8.178 & 0.026 & - 0.008 & 0.142 & - 0.104 & 0.014 \\ 0.033 & - 0.025 & 0.026 & - 8.178 & 0.142 & - 0.008 & - 0.104 & 0.014 \\ 0. & - 0.031 & - 0.008 & 0.142 & - 8.764 & 0.012 & 0.053 & 0.019 \\ 0. & - 0.031 & 0.142 & - 0.008 & 0.012 & - 8.764 & 0.053 & 0.019 \\ 0.012 & 0.026 & - 0.104 & - 0.104 & 0.053 & 0.053 & - 8.226 & 0.041 \\ 0.024 & 0.019 & 0.014 & 0.014 & 0.019 & 0.019 & 0.041 & - 8.252\end{matrix} )$$

which is decomposed to 36 Pauli operators and corresponds to the groundstate energy of −8.93992 Ha. Together with the nuclear repulsion energy of 1.05835 Ha, the total SCI groundstate energy amounts to −7.88157 Ha, which is 0.79 mHa away from the exact FCI total energy, given by −7.88236 Ha.

A frame of ten time bins was fixed, each of 100 dt, to a total duration of 1000dt=222 ns, per channel. Harboring the linear topology of ibmq_jakarta, led to two bidirectional two-qubit channels, and three single qubit channels, amounting to 7 channels and a total of 140 real tunable parameters. Optimizing this pulse setup with noiseless simulations reached a total ground state energy of −7.880692 Ha, corresponding to Δ_{FCI}=1.67 mHa and Δ_{SCI} =0.88 mHa. Noisy simulations of the same setup on ibmq_osaka resulted with Δ_{FCI}=4.06 mHa. The noiseless simulation outcome highlights the impact of the two-qubit control channels: accounting for only single-qubit drive channels in noiseless simulations yields a higher value of Δ_{FCI} ≈4 mHa. The optimization process of this setup with 140 tunable parameters was notably time-consuming, requiring thousands of iterations for convergence. This is attributed to the choice of the gradient-free COBYLA optimizer. Employing gradient-based optimizers would necessitate an analog to the parameter shift rule [32-34].

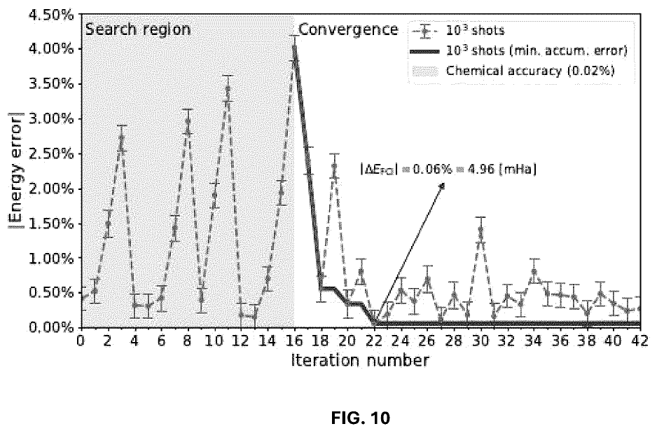

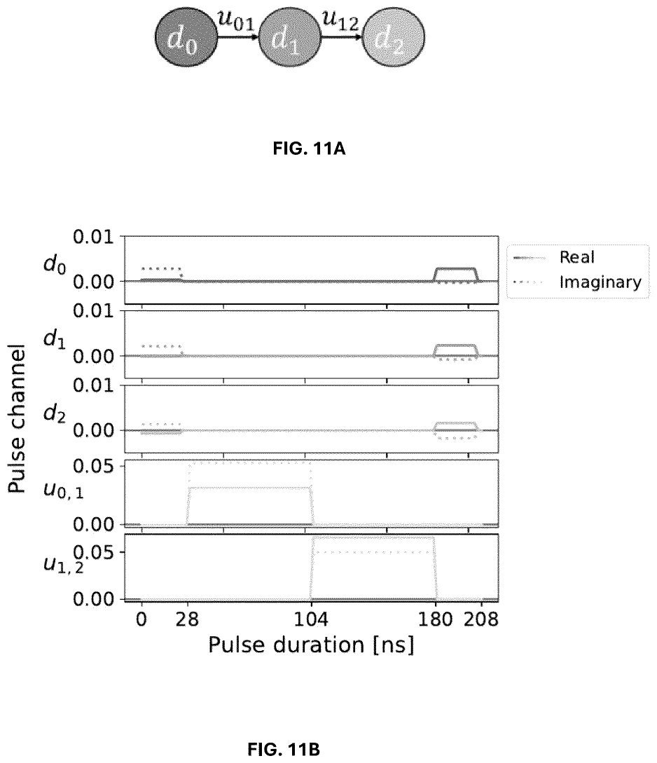

The real-hardware executions, using 10³ shots, were performed upon the ibmq_brisbane quantum computer, in which 1dt=0.5 ns. Reference is made to FIGS. 10, 11A-11B. FIG. 10 shows real-hardware (ibmq brisbane) freestyle pulse results for LiH at equilibrium distance using 103 shots. Percentage error deviation from exact FCI energy shown in absolute value, per iteration. The dark green curve depicts the minimal accumulated error at each iteration. The light green area marks the c.a. region.

FIG. 11A illustrates the 3-qubit topology featuring three drive channels, one assigned to each qubit i, and two control channels, denoted as ui, where k is the controlling qubit and l is the target qubit. FIG. 11B shows the real-hardware pulse schedule that most closely approximated the FCI groundstate energy for LiH (found at the 23rd iteration (see FIG. 9). The y-axis displays the optimized pulse amplitudes, while the x-axis outlines the timeline of the pulse. Solid and dotted lines indicate real and imaginary components of the pulse amplitudes, respectively. Here, dᵢ denotes the three single-qubit control channels, and uk,l signifies the two two-qubit interaction channels.

More specifically, FIG. 11A shows the linear topology of the three qubits from the ibmq_brisbane quantum device that were used. The setup involved a single complex drive channel for each qubit, in addition to two complex directed 2-qubit control channels, resulting in a total of five pulse channels. To facilitate the executions, a compact pulse setup was fixed, with 16 tunable real parameters. To that end, only uni-directional control pulses were enabled and the following 4 time-bins sequence was fixed: all drive channels (56 dt)→first and second controls in turn (152dt each)→all drive channels (56 dt), reaching a total duration of 416 dt. Few tens of iterations were sufficient to recover the FCI energy to within 4.96 mHa, as shown in FIG. 10. It should be noted, although not specifically shown here that an experiment with 10² shots achieved comparable results). FIG. 11B depicts the most accurate 3-qubit 5 channels pulse generating the LiH groundstate attained on real-hardware, corresponding to the 23'rd iteration in the convergence process shown in FIG. 10. A distinction between search and convergence region is made.

In comparison, a 3-qubit, depth-2 Ansatz, shown to be sufficient within VQ-SCI for c.a. groundstate determination of the LiH molecule [26], results in a pulse duration of ≈1250 ns, six times longer than the freestyle pulse of the present disclosure. Moreover, the freestyle pulse attains much better accuracy on real-hardware, see Table 5 demonstrating LiH groundstate pulse calculations at the equilibrium interatomic distance (1.5 Ang). Per study, the table specifies: qubits number, utilized method, pulse duration, deviation from the FCI energy (−7.88236 Ha), and calculation type (noisy simulation or real-hardware).

TABLE 5

| | #q | alg. | T [ns] | Δ_{FCI} [mHa] | Calc. type |
|---|---|---|---|---|---|
| Ctrl-VQE [26] | 4 | VQE | 40 | 2.17 | Noisy sim. |
| PANSATZ [21] | 4 | VQE | 50 | 20 | Noisy sim. |
| Gate model [26] | 3 | VQ-SCI | 1250 | 2.5 | Noisy sim. |
| Freestyle of the present | 3 | VQ-SCI | 222 | 4.06 | Noisy sim. |
| disclosure | | | | | |
| NAPA [18] | 4 | VQE | 199 | 292 | RH |
| Gate model [26] | 3 | VQ-SCI | 1250 | 81 | RH |
| Freestyle of the present | 3 | VQ-SCI | 208 | 4.96 | RH |
| disclosure | | | | | |

Comparing further with previous pulse-based noisy-simulations of LiH, it is noted that using the technique of Ref [26] a shorter and more accurate pulse was found, albeit using a simplified pulse model, and using the technique of Ref [21] a shorter pulse was reached, but with degraded accuracy. Finally, real-hardware pulse optimization of Ref. [18] reached a pulse of comparable duration to the duration obtained in the present disclosure, but with a much higher FCI energy deviation.

In the process of measuring the components of the Hamiltonian, see Eq. (8) above, the identity term Î is straightforwardly added without physical measurement, the \hat{Z} term is measured in the standard computational basis, and the X term requires a simple basis transformation using the Hadamard gate.

As noted above, with reference to FIGS. 5A and 5B, also with regards to LiH, the technique of the present disclosure may include determining a dissociation curve of the molecule by repeating the iterative pulse optimization for multiple interatomic distances.

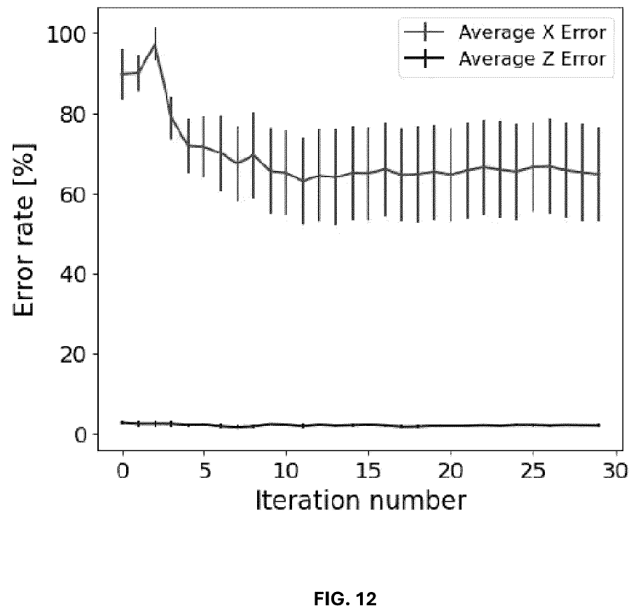

To pinpoint the source of errors in the results, the inventors conducted a thorough analysis focusing on measurement errors. The strategy involved leveraging the known groundstate of the H₂ molecule, as determined by the VQ-SCI method (see Eq. (9) above). This allowed calculation of the precise expectation values. The results of this analysis are presented in FIG. 12 which illustrates error deviation of \hat{X} and \hat{Z} measurement from the expected values of the FCI groundstate on the equilibrium of H₂ molecule.

This figure includes multiple iterations of the experiment performed on the ibmq_jakarta quantum device, all conducted using a single time step (dt) and the same number of shots (10⁵). These results are based on the same experiments presented in the blue curve in FIG. 7. FIG. 12 focuses on the measurement errors of the expectation values of the \hat{Z} and \hat{X} operators. Each point represents the average of 4 different freestyle pulse experiments. The analysis revealed a notable difference in the measurement accuracy between the two operators. Specifically, the expectation value for the \hat{X} operator showed a significant deviation, saturating at ≈60% measurement error, whereas the \hat{Z} operator measurements were more accurate, with deviations at ≈5%.

It should be noted that in the specific Hamiltonian of Eq. (8) above, the contribution of the \hat{Z} term to the overall measurement is approximately four times greater than that of the \hat{X} term and is hence much more dominant. In addition, the two terms are of opposite signs, giving rise to occasional observed measurement error cancellation.

Thus, in calculating the LiH groundstate, the technique of the present disclosure achieved unparalleled accuracy with pulse sequences significantly shorter than those generated by traditional gate-based circuits. These results underscore the potential advantages of delving into the hardware degrees of freedom. Finally, while the demonstrations described above focus on finding molecular groundstate energies, the approach is general and adaptable to various VQAs and hardware technologies.

Thus, the technique of the present disclosure provides the freestyle pulse optimization scheme that provides full flexibility in pulse design. It differs from fixed-shape pulse methods in its ability to generate pulses of diverse, irregular, shapes. Additionally, unlike prior discrete-time pulse methods, the freestyle pulse optimization scheme accommodates two-qubit channels, thus enhancing its efficiency and compatibility with real quantum devices.

It should be understood that although the pulse optimization technique of the present disclosure is described below with reference to a superconducting quantum system and although this technique is specifically discussed and exemplified herein for the cost function ƒ_{C}( [symbol] ) representing a molecular groundstate energy of a chemical system, the principles of the present disclosure should not be limited to these specific examples. The pulse optimization technique of the present disclosure can be used for optimizing a cost function for a selected variational quantum algorithm to be performed by a quantum computing system of any of the following types: superconducting qubit systems, trapped ion systems, neutral atom array systems, quantum dot systems, nitrogen-vacancy center systems.

1. A method for pulse optimization in quantum computing, the method comprising:
providing quantum computing system related data comprising a number q of qubits (q≥2), and time-dependent complex pulse amplitudes dₖ(t) and u_{{k,l}}(t) of, respectively, tunable single-qubit control channels and tunable two-qubit interaction channels of the quantum computing system;
determining data indicative of a cost function ƒ_{C} ( [symbol] ) for a selected variational quantum algorithm to be performed by said quantum computing system, where \vec{θ} is a predefined vector of pulse parameters; wherein said vector of pulse parameters is predefined by carrying out the following:
discretizing a continuous pulse into a pulse sequence of N pulses, each of a pulse duration dt, and representing each of the single-qubit control pulses and each of the two-qubit interaction pulses by the pulse sequence of the N pulses, where the pulse sequence of the single-qubit control pulse is represented by real and imaginary components of the time-dependent complex amplitudes dₖ(t) and the pulse sequence of the control two-qubit interaction pulse is represented by the time-dependent complex amplitudes u_{{k,l}}(t), such that said vector of pulse parameters, [symbol] , is a multi-parameter vector across multiple pulse sequences of the single-qubit control pulses and two-qubit interaction pulses; and
starting from initial values for said pulse parameters, optimizing values of the pulse parameters, by iteratively varying said values of pulse parameters of said vector, [symbol] , while evaluating the cost function ƒ_{C}( [symbol] ) by measurements of the q qubits in said quantum computing system until convergence criteria are met, wherein the pulse parameters at each time bin are independently optimized as free parameters to obtain a minimized cost function ƒ_{C}( [symbol] ); and determining an optimized representation [symbol] of the vector of pulse parameters corresponding to the minimized cost function ƒ_{C}( [symbol] ).

2. The method according to claim 1, wherein said quantum computing system is configured as one of the following: a superconducting qubit system, trapped ion systems, neutral atom array systems, nitrogen-vacancy center systems, or quantum dot system.

3. The method according to claim 1, wherein the selected variational quantum algorithm is selected from the following: Variational Quantum Eigensolver (VQE), Variational Quantum Selected Configuration-Interaction (VQ-SCI), Quantum Approximate Optimization Algorithm (QAOA), and variational quantum machine learning algorithms.

4. The method according to claim 1, wherein said optimizing values of the pulse parameters comprises iterative pulse optimization performed using a gradient-free optimizer.

5. The method according to claim 1, wherein said optimizing values of the pulse parameters comprises iterative pulse optimization performed using a gradient-based optimizer.

6. The method according to claim 1, wherein the initial values for the pulse parameters are set to zero, corresponding to an initial computational basis state of the quantum computing system.

7. The method according to claim 1, wherein the convergence criteria comprise at least one of the following: the cost function ƒ_{C}( [symbol] ) changing by less than a predetermined threshold between consecutive iterations; achieving a target accuracy for the cost function; and reaching a maximum number of iterations.

8. The method according to claim 7, wherein the convergence criteria comprise achieving a target accuracy for the cost function, the target accuracy being chemical accuracy, defined as an energy deviation of ±0.0016 Ha (Hartree) from a Full Configuration Interaction (FCI) energy.

9. The method according to claim 1, wherein the cost function ƒ_{C}( [symbol] ) represents a molecular groundstate energy of a chemical system.

10. The method according to claim 9, further comprising determining a dissociation curve of a molecule by repeating the iterative pulse optimization for multiple interatomic distances.

11. The method according to claim 1, wherein the pulse sequence comprises discrete-time pulses with independently tunable amplitude within each time bin dt.

12. The method according to claim 1, wherein said optimizing values of the pulse parameters comprises updating the pulse parameters by a classical computer based on the measurements of the q qubits in the quantum computing system.

13. The method according to claim 1, wherein the duration dt of each pulse in the pulse sequence is selected based on a characteristic control timescale of the quantum computing system.

14. The method according to claim 1, wherein the quantum computing system is a superconducting qubit system, the pulse duration dt of each pulse in the pulse sequence being selected between 0.1 ns and 100 ns based on a characteristic control timescale of the quantum computing system.

15. The method according to claim 1, wherein the quantum computing system is a trapped ion system, or a neutral atom array system, the pulse duration dt of each pulse in the pulse sequence is selected between 0.1 μs and 100 μs based on a characteristic control timescale of the quantum computing system.

16. The method according to claim 1, comprising optimizing the number N of pulses and/or the pulse duration dt to provide an optimized total pulse duration N×dt of the pulse sequence to be less than a coherence time of the quantum computing system.

17. The method according to claim 16, wherein the total pulse duration N×dt approaches a quantum speed limit for state preparation in the quantum computing system.

18. The method according to claim 1, wherein the quantum computing system is configured with all-to-all topology for connecting the q qubits, and wherein a total number q² of channels is defined by number q of the control single-qubit channels and number q(q-1) of the two-qubit interaction channels, providing a total number of 2Nq² of the tunable pulse parameters.

19. The method according to claim 1, wherein the quantum computing system is configured with a linear topology for connecting the q qubits, and wherein a total number (3q-2) of channels is defined by number q of the control single-qubit channels and number (q-1) of the two-qubit interaction channels, each of the two-qubit interaction channel having 2 directions of control, providing a total number 2N(3q−2) of the tunable pulse parameters.

20. The method according to claim 1, wherein the two-qubit interaction channels are bidirectional, comprising a first interaction channel for qubit k interacting with qubit l and a second interaction channel for the qubit l interacting with the qubit k.

21. The method according to claim 1, wherein the two-qubit interaction channels are unidirectional.

22. The method according to claim 1, wherein the measurements of the q qubits comprise measuring expectation values of observable operators.

23. The method according to claim 22, wherein the observable operators include at least Pauli \hat{Z} and \hat{X} operators.

24. The method according to claim 1, wherein the evaluating of the cost function comprises:
applying the pulse sequence defined by current values of 0\vec{ } to the quantum computing system;
performing multiple measurement shots on the q qubits;
calculating expectation values from the measurement results; and
computing the cost function ƒ_{C}( [symbol] ) from the expectation values.

25. The method according to claim 1, comprising modifying the pulse sequence to meet hardware-specific constraints of the quantum computing system on at least one of the pulse duration dt, timing, and pulse shape.

26. The method according to claim 1, comprising analysis of the iterative pulse optimization performed in a rotating frame or interaction picture corresponding to the quantum computing system.

27. The method according to claim 26, wherein for the quantum computing system operating in a rotating wave approximation, a real component Re[dk(t)] of the single-qubit control pulse amplitude generates rotation around a first axis of a Bloch sphere representation; and an imaginary component Im[dk(t)] of the single-qubit control pulse amplitude generates rotation around a second orthogonal axis of the Bloch sphere representation.

28. The method according to claim 26, wherein the iterative pulse optimization provides an effective pulse sequence that implements a rotation operation around one or more axes of a Bloch sphere representation.

29. The method according to claim 1, further comprising analyzing the measured data to identify and monitor leakage relating errors arising from coupling to states outside a computational subspace of the qubits.

30. The method according to claim 1, providing for the cost function minimization for a given variational quantum algorithm with the pulse duration dt at least 10 times shorter than a pulse duration of a gate-based circuit implementing said given variational quantum algorithm.

31. The method according to claim 1, wherein said minimized cost function ƒ_{C} ( [symbol] ) is obtained subject only to physical amplitude constraints |dₖ(t)|²≤1 and |u_{{k,l}}(t)|²≤1, the physical amplitude constraints comprising platform-specific maximum control amplitudes determined by hardware limitations of the quantum computing system.

32. A quantum computing system configured to perform the method of claim 1.

33. A system comprising:
a quantum computing system comprising: a quantum chip comprising q qubits (q≥2), a pulse generator, and a readout circuitry, the quantum computing system defining tunable single-qubit control channels having a time-dependent complex pulse amplitude dₖ(t) and tunable two-qubit interaction channels having a time-dependent complex pulse amplitude u_{{k,l}}(t) for generating entanglement between qubit pairs; and
a control circuitry configured and operable to generate control pulses for the quantum computing system to provide said tunable single-qubit control channels said tunable two-qubit interaction channels, the control circuitry comprising:
a pulse optimizer configured and operable to utilize said data indicative of the time-dependent complex pulse amplitudes dₖ(t) and u_{{k,l}}(t) and transfer a continuous pulse into an optimized pulse sequence representation corresponding to a minimized cost function for a selected variational quantum algorithm to be performed by said quantum computing system, by carrying out the following:
representing the cost function as ƒ_{C}( [symbol] ), where [symbol] is a predefined vector of pulse parameters;
discretizing the continuous pulse into a pulse sequence of N pulses, each of a pulse duration dt, and representing each of the single-qubit control pulses and each of the two-qubit interaction pulses by the pulse sequence of the N pulses, where the pulse sequence of the single-qubit control pulse is represented by real and imaginary components of the time-dependent complex amplitudes dₖ(t) and the pulse sequence of the control two-qubit interaction pulse is represented by the time-dependent complex amplitudes u_{{k,l}}(t), such that said vector of pulse parameters, [symbol] , is a multi-parameter vector across multiple pulse sequences of the single-qubit control pulses and two-qubit interaction pulses;
optimizing values of the pulse parameters, by iteratively varying said values of pulse parameters of said vector, [symbol] , starting from selected initial values, while evaluating the cost function ƒ_{C}( [symbol] ) by using measured data provided the classical controller and being indicative of measurements of the q qubits in said quantum computing system, until convergence criteria for the cost function are met, wherein the pulse parameters at each time bin are independently optimized as free parameters to obtain a minimized cost function ƒ_{C}( [symbol] ); and
determining an optimized representation [symbol] of the vector of pulse parameters corresponding to the minimized cost function ƒ_{C} ( [symbol] ).

34. A control circuitry configured and operable to generate control pulses for a qubit chip of a quantum computing system, the control circuitry comprising a pulse optimizer configured and operable to carry out the following:
utilize data indicative of a number q of 2 or more qubits in said qubit chip, and time-dependent complex pulse amplitudes dₖ(t) and u_{{k,l}}(t) of, respectively, tunable single-qubit control channels and tunable two-qubit interaction channels of the quantum computing system and determine a cost function for a selected variational quantum algorithm to be performed by said quantum computing system as ƒ_{C}( [symbol] ), where [symbol] is a predefined vector of pulse parameters
optimize said vector of pulse parameters to minimize the cost function by carrying out the following:
discretizing the continuous pulse into a pulse sequence of N pulses, each of a pulse duration dt, and representing each of the single-qubit control pulses and each of the two-qubit interaction pulses by the pulse sequence of the N pulses, where the pulse sequence of the single-qubit control pulse is represented by real and imaginary components of the time-dependent complex amplitudes dₖ(t) and the pulse sequence of the control two-qubit interaction pulse is represented by the time-dependent complex amplitudes u_{{k,l}}(t), such that said vector of pulse parameters, [symbol] , is a multi-parameter vector across multiple pulse sequences of the single-qubit control pulses and two-qubit interaction pulses;
optimizing values of the pulse parameters, by iteratively varying said values of pulse parameters of said vector, [symbol] , starting from selected initial values, while evaluating the cost function ƒ_{C} ( [symbol] ) by using measured data indicative of measurements of the q qubits in said quantum computing system, until convergence criteria for the cost function are met, wherein the pulse parameters at each time bin are independently optimized as free parameters to obtain a minimized cost function ƒ_{C}( [symbol] ); and
determining an optimized representation [symbol] of the vector of pulse parameters corresponding to the minimized cost function ƒ_{C}( [symbol] ).
